(19) United States
(12) Patent Application Publication
(10) Pub. No.: US 2026/0304249 A1
(43) Pub. Date: Oct. 1, 2026

(54) METHOD AND APPARATUS FOR CONFIGURING HANDOVER IN WIRELESS COMMUNICATION SYSTEM

(71) Applicant: Samsung Electronics Co., Ltd., Suwon-si, Gyeonggi-do (KR)

(72) Inventor: Seungri JIN, Suwon-si (KR)

(21) Appl. No.: 19/475,656

(22) PCT Filed: Mar. 22, 2024
(86) PCT No.: PCT/KR2024/003630

§ 371 Date: Oct. 15, 2025

(30) Foreign Application Priority Data
May 11, 2023 (KR) 10-2023-0061002
May 11, 2023 (KR) 10-2023-0061012

(51) Int. Cl. H04W 36/00; H04W 36/08; H04W 36/32; H04W 72/29; H04W 88/08

(52) U.S. Cl. CPC H04W 36/0072; H04W 36/087; H04W 36/324; H04W 72/29; H04W 88/085

(57) ABSTRACT

The present disclosure relates to a 5G or 6G communication system for supporting a higher data transmission rate and, more particularly, discloses a method for transmitting a signal for L1/L2-based handover, including operations of a CU configured to transmit, to a distributed unit (DU), a request message including L1/L2 triggered mobility (LTM) resource configuration information and receive, from the DU, a response message including LTM report configuration information.

### TECHNICAL FIELD

The disclosure generally relates to a wireless communication system and, more particularly, to a method and a apparatus for transmitting a signal for L1/L2-based handover in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Based on the discussion described above, the disclosure is to provide an apparatus and a method for, in a wireless communication system, when a terminal is receiving a service via a specific beam from a current serving cell, measuring and reporting a beam belonging to another cell, and if a beam of a neighboring cell is better, performing cell changing to the neighboring cell. Particularly, the disclosure proposes a configuration method for performing Layer 1 measurement of neighboring cells for subsequent Layer 1/Layer 2 (L1/L2)-based handover (L1/L2 triggered mobility (LTM)), and a method for reporting or controlling a Layer 1 measurement value obtained via L1/L2 signaling.

### Solution to Problem

According to various embodiments of the disclosure, a method for processing a control signal in a wireless communication system may include receiving a first control signal transmitted from a base station, processing the received first control signal, and transmitting, to the base station, a second control signal generated based on the processing.

### Advantageous Effects of Invention

Embodiments of the disclosure provide an apparatus and a method capable of effectively providing services in a wireless communication system.

Embodiments of the disclosure provide an apparatus and a method, in which, via Layer 1-based beam measurement, an operation of subsequent L1/L2 signaling-based handover to neighboring cells can be supported, a delay time can be reduced compared to an existing procedure, and data transmission and reception are possible after beam changing to another cell.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a structure of a wireless communication system according to an embodiment of the disclosure.

FIG. 2 illustrates a radio protocol structure of a wireless communication system according to an embodiment of the disclosure.

FIG. 3 illustrates a structure of another wireless communication system according to an embodiment of the disclosure.

FIG. 4 illustrates a scenario in which, while maintaining a connection state with a serving cell, a UE transmits and receives data via a beam of a transmission and reception point (TRP) of a neighboring cell supporting L1/L2-based beam change, according to an embodiment of the disclosure.

FIG. 5 illustrates a scenario in which a UE transmits and receives data by changing a serving cell and a beam to a TRP of a cell supporting an L1/L2-based beam change, according to an embodiment of the disclosure.

FIG. 6 illustrates a signal flow for supporting a subsequent L1/L2-based handover (L1/L2 triggered mobility (LTM)) operation, according to an embodiment of the disclosure.

FIG. 7 illustrates another L1 signal flow for supporting a subsequent L1/L2-based handover (LTM) operation, according to an embodiment of the disclosure.

FIG. 8 illustrates an operation flow of a UE for performing L1/L2-based beam changing and handover, according to an embodiment of the disclosure.

FIG. 9 illustrates an operation flow of a base station for performing L1/L2-based beam changing and handover, according to an embodiment of the disclosure.

FIG. 10 illustrates a discontinuous reception (DRX) operation for a UE in a radio resource control (RRC) connected state, according to an embodiment of the disclosure.

FIG. 11 illustrates a method of configuring channel state information (CSI) resources in a wireless communication system, according to an embodiment of the disclosure.

FIG. 12 illustrates CSI resource reporting method configuration in a wireless communication system, according to an embodiment of the disclosure.

FIG. 13 illustrates a triggering state configuration for CSI resource reporting in a wireless communication system, according to an embodiment of the disclosure.

FIG. 14 illustrates an L1/L2 signaling method for supporting a subsequent L1/L2-based handover (L1/L2 triggered mobility (LTM)) operation, according to an embodiment of the disclosure.

FIG. 15 illustrates a method of transmitting an L1 measurement report for subsequent LTM when DRX is configured and applied, according to an embodiment of the disclosure.

FIG. 16 illustrates a signal flow for semi-persistent L1 measurement reporting to support a subsequent L1/L2-based handover (LTM) operation, according to an embodiment of the disclosure.

FIG. 17 illustrates an operation in which aperiodic L1 measurement reporting is applied to support a subsequent L1/L2-based handover (LTM) operation, according to an embodiment of the disclosure.

FIG. 18 illustrates another operation flow of a UE for performing L1/L2-based beam changing and handover, according to an embodiment of the disclosure.

FIG. 19 illustrates another operation flow of a base station for performing L1/L2-based beam changing and handover, according to an embodiment of the disclosure.

FIG. 20 illustrates a functional structure of a UE according to an embodiment of the disclosure.

FIG. 21 illustrates a functional structure of a base station according to an embodiment of the disclosure.

### MODE FOR THE INVENTION

Hereinafter, the operation principle of the disclosure will be described in detail in conjunction with the accompanying drawings. In describing the disclosure below, a detailed description of relevant known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification. In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) standards will be used for the sake of descriptive convenience. However, the disclosure is not limited by these terms and names, and may be applied in the same way to systems that conform other standards.

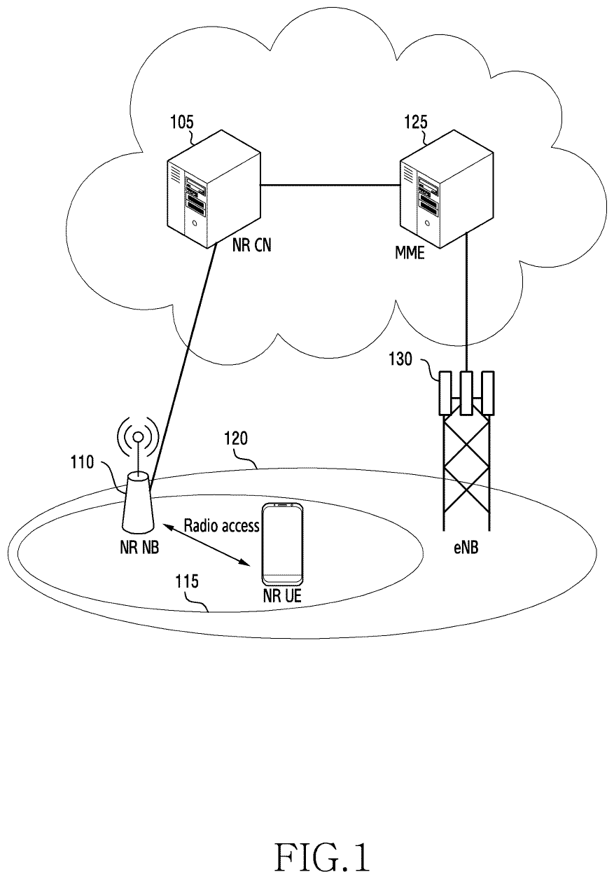

FIG. 1 illustrates a structure of a wireless communication system according to an embodiment of the disclosure.

Referring to FIG. 1, a radio access network of a next-generation mobile communication system may include a next-generation base station (new radio node B, hereinafter NR NB) 110 and a new radio core network (NR CN) or next generation core network (NG CN) 105. A user terminal (new radio user equipment, hereinafter NR UE or terminal) 115 may access an external network via the NR NB 110 and the NR CN 105.

In FIG. 1c, the NR NB 110 may correspond to an evolved Node B (eNB) of a conventional LTE system. The NR NB 110 may be connected to the NR UE 115 through a radio channel and may provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR NB 110 may serve as the device. In general, one NR NB may control multiple cells. In order to implement ultrahigh-speed data transfer beyond the current LTE, the next-generation mobile communication system may provide a wider bandwidth than the existing maximum bandwidth, may employ an orthogonal frequency division multiplexing (OFDM) as a radio access technology, and may additionally use a beamforming technology. Furthermore, the next-generation mobile communication system may employ an adaptive modulation & coding (AMC) scheme for determining a modulation scheme and a channel coding rate according to a channel state of a UE. The NR CN 105 may perform functions such as mobility support, bearer configuration, and QoS configuration. The NR CN is a device responsible for various control functions as well as a mobility management function for a UE, and may be connected to multiple base stations. In addition, the next-generation mobile communication system may interwork with the conventional LTE system, and the NR CN may be connected to a mobility management entity (MME) 125 via a network interface. The MME may be connected to an eNB 130 that is an existing base station.

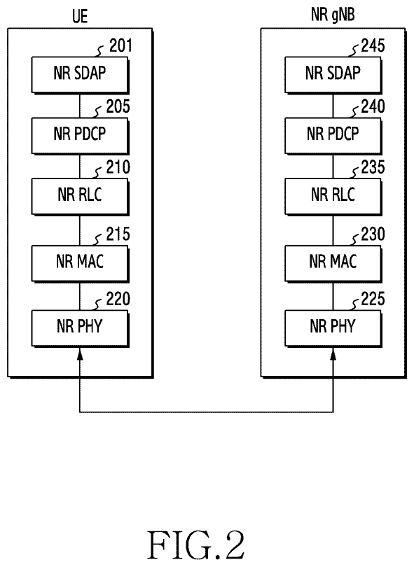

FIG. 2 illustrates a radio protocol structure of a wireless communication system according to an embodiment of the disclosure.

Referring to FIG. 2, a radio protocol of a next-generation mobile communication system may include an NR service data adaptation protocol (SDAP) 201 or 245, an NR packet data convergence protocol (PDCP) 205 or 240, an NR radio link control (RLC) 210 or 235, and an NR medium access controls (MAC) 215 or 230 on each of UE and NR base station sides.

The main functions of the NR SDAP 201 or 245 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 205 or 240 may include some of functions below.
Header compression and decompression: robust header compression (ROHC) only
Transfer of user data
In-sequence delivery of upper layer protocol data units (PDUs)
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in uplink

The above-mentioned reordering of the NR PDCP device may refer to a function of reordering PDCP PDU received from a lower layer in an order based on PDCP sequence numbers (SNs). The reordering of the NR PDCP device may include a function of delivering data to the upper layer in a reordered sequence, or may include a function of delivering data to the upper layer directly without considering the sequence. Alternatively, the reordering of the NR PDCP device may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 210 or 235 may include some of functions below.
Transfer of upper layer PDUs
In-sequence delivery of upper layer PDUs
Out-of-sequence delivery of upper layer PDUs
Error Correction through ARQ (automatic repeat request)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device may refer to a function of successively delivering RLC SDUs received from the lower layer to the upper layer. The NR RLC device may include a function of, if multiple RLC SDUs segmented from one original RLC SDU have been received, reassembling the received RLC SDUs and transferring the same, and may include a function of rearranging the received RLC SDUs based on the RLC sequence number (SN) or PDCP sequence number (SN). The NR RLC device may include a function of recording RLC PDUs lost as a result of reordering, may include a function of reporting the state of the lost RLC PDUs to the transmitting side, and may include a function of requesting retransmission of the lost RLC PDUs. Alternatively, the NR RLC device may include a function of, if there is a lost RLC SDU, successively delivering only RLC SDUs before the lost RLC SDU to the upper layer, may include a function of, if a predetermined timer has expired although there is a lost RLC SDU, sequentially delivering all RLC SDUs received before the timer was started to the upper layer, or may include a function of, if a predetermined timer has expired although there is a lost RLC SDU, sequentially delivering all RLC SDUs received up to present to the upper layer. In addition, the in-sequence delivery of the NR RLC device may process RLC PDUs in the received order (e.g., regardless of the sequence number order, in the order of arrival) and deliver same to the PDCP device regardless of the order (out-of-sequence delivery), and may, in the case of segments, receive segments which are stored in a buffer or which are to be received later, reconfigure same into one complete RLC PDU, and then process and deliver same to the PDCP device. The NR RLC layer may include no concatenation function, which may be performed in the NR MAC layer or replaced with a multiplexing function of the NR MAC layer.

The in-sequence delivery of the NR RLC device may refer to a function of, if there is a lost RLC PDU, delivering only RLC SDUs before the lost RLC PDU to the upper layer in sequence. The out-of-sequence delivery of the NR RLC device may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 215 or 230 may be connected to multiple NR RLC layer devices configured in a single UE, and the main functions of the NR MAC may include some of functions below.
Mapping between logical channels and transport channels
Multiplexing/demultiplexing of MAC SDUs
Scheduling information reporting
Error correction through HARQ (hybrid automatic repeat request)
Priority handling between logical channels of one UE
Priority handling between UEs by means of dynamic scheduling
Multimedia broadcast multicast service (MBMS) service identification
Transport format selection
Padding

An NR PHY layer 220 or 225 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

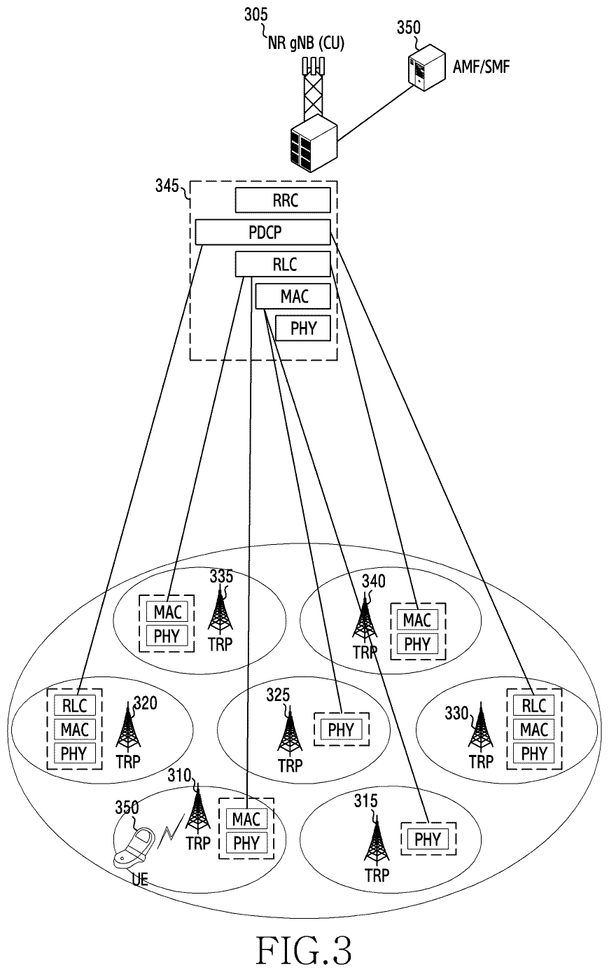

FIG. 3 illustrates a structure of another wireless communication system according to an embodiment of the disclosure.

Referring to FIG. 3, a cell serviced by an NR gNB 305 operating based on a beam may include multiple transmission reception points (TRPs) 310, 315, 320, 325, 330, 335, and 340. The TRPs 310 to 340 represent a block obtained by separating some functions for transmitting/receiving physical signals from a conventional NR eNB, and may include multiple antennas.

The NR gNB 305 may also be expressed as a central unit (CU), and a TRP may also be expressed as a distributed unit (DU). Functions of the NR gNB 305 and TRPs may be configured by separating the respective layers from PDCP/RLC/MAC/PHY layers as in the protocol 345. That is, the TRPs may each include only a PHY layer and perform the functions of the corresponding layer (315 and 325), may each include only a PHY layer and an MAC layer and perform the functions of the corresponding layers (310, 335, and 340), or may each include only a PHY layer, an MAC layer, and an RLC layer and perform the functions of the corresponding layers (320 and 330),

In particular, the TRPs 310 to 340 may use a beamforming technology in which multiple transmission/reception antennas are used to generate narrow beams in several directions and transmit/receive data therethrough. A UE 350 may access the NR gNB 305 and external networks through the TRPs 310 to 340. The NR gNB 305 may collects state information, such as buffer states, available transmission power states, and channel states of UEs, and perform scheduling accordingly in order to service users, and may support connections between the UEs and a core network (CN), particularly, access and mobility management function (AMF)/session management function (SMF) 350.

According to various embodiments, the TRPs have default structures 315 and 325 in which the TRP has only a PHY layer and may perform the functions of the corresponding layer.

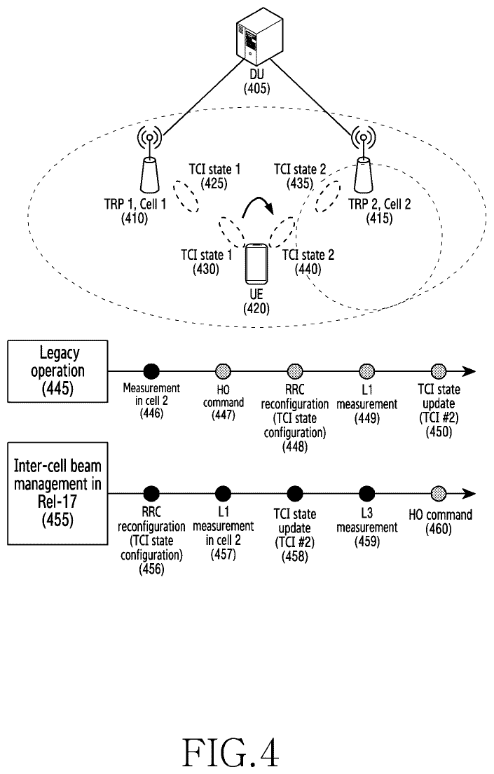

FIG. 4 illustrates a scenario in which, while maintaining a connection state with a serving cell, a UE transmits and receives data via a beam of a transmission and reception point (TRP) of a neighboring cell supporting L1/L2-based beam change, according to an embodiment of the disclosure. More specifically, referring to FIG. 4, a scenario for inter-cell beam management is illustrated as a scenario in which a UE transmits and receives data via a beam of a TRP of a neighboring cell supporting L1/L2-based beam change, while maintaining a connection state with a serving cell.

In this drawing, a case where multiple cells (TRP1-Cell1 and TRP2-Cell2) 410 and 415 exist within a single distributed unit (DU) 405 is illustrated, but various embodiments of the disclosure are also applicable to a case of inter-DU (e.g., respective DUs constitute one TRP-Cell). In addition, according to various embodiments of the disclosure, L1/L2-based mobility (e.g., beam change and serving cell change) is supported, but a cell (TRP 2, cell 2) other than a serving cell may be apparently interchangeably referred to as a neighboring cell, a non-serving cell, an additional cell having a physical cell ID (PCI) different from that of the serving cell, or the like.

Referring to an existing UE beam change procedure 445, a UE 420 may transmit and receive data in a connected state via TRP 1 410 of serving cell 1, and may be configured with an optimal beam, i.e., a transmission configuration indicator (TCI) state 1 425 or 430. In this step, the UE may receive, from the serving cell 410 via RRC configuration information, configuration information for L3 channel measurement (radio resource management (RRM)) on an additional cell (TRP 2-Cell 2) 415 having a PCI different from that of the serving cell, and may perform an L3 measurement operation 446 on a corresponding frequency and cell. Subsequently, based on a reported measurement value, the serving cell (TRP 1-Cell 1) 410 may indicate 447 a handover to the cell (TRP 2-Cell 2) 415. After the handover is completed, additional RRC configuration information may be transferred 448 to the UE 420 via TRP 2-Cell 2 415. The additionally transferred RRC configuration information may include uplink (UL)/downlink (DL) configuration information in the corresponding cell, L1 measurement-related configurations (e.g., CSI-RS measurement and reporting), etc., and may particularly include TCI state configuration information for a physical downlink control channel (PDCCH) and a physical downlink shared channel (PDSCH). The UE may perform L1 measurement 449 according to the received configuration. A base station may update 450 the TCI state via L1/L2 signaling according to the measurement report. Here, TCI state 2 440 that is an optimal beam may be indicated. In this step, before the handover, the serving cell is cell 1, and after the handover, cell 2 may become the serving cell. That is, until the optimal beam is indicated, a large number of procedures and much time may be required even after the handover.

Unlike the existing UE beam change procedures 445 described above, an enhanced beam change technique 455 according to various embodiments of the disclosure is as follows. The UE may receive, from the serving 410, a beam configuration associated with the additional cell (TRP 2-Cell 2) 415 having a PCI different from that of the serving cell 410 via RRC configuration information 456. For the beam configuration associated with the additional cell (TRP 2-Cell 2) 415 having the PCI different from that of the serving cell (e.g., a part associating a corresponding TCI state to TRP2), a method of associating and indicating a new cell ID (physical cell ID (PCI)) (e.g., additionalPCI-r17) may be applied as follows.

| | |
|---|---|
| TCI-State ::= | SEQUENCE { |
| tci-StateId | TCI-StateId |
| qcl-Type1 | QCL-Info, |

| qcl-Type2 | QCL-Info |
|---|---|
| OPTIONAL, -- Need R | |
| ..., | |
| [[ | |
| additionalPCI-r17 | AdditionalPCIIndex-r17 |
| OPTIONAL, -- Need R | |
| pathlossReferenceRS-Id-r17 | PUSCH- |
| PathlossReferenceRS-Id | OPTIONAL, -- Cond |
| JointTCI | |
| ul-powerControl-r17 | Uplink-powerControlId-r17 |

OPTIONAL -- Cond JointTCI
]]
}

According to an embodiment, a unified TCI state framework may also be applied for beam management between the cells. The unified TCI state framework is a framework in which a common TCI state framework is applied to uplink, downlink, common channels, and dedicated channels, and may be configured to either a joint UL/DL mode or a separate UL/DL mode.

MIMOParam-r17 ::= SEQUENCE {

| | |
|---|---|
| additionalPCI-ToAddModList-r17 | SEQUENCE |

(SIZE(1..maxNrofAdditionalPCI-r17)) OF SSB-MTC-AdditionalPCI-
r17 OPTIONAL, -- Need N

| | |
|---|---|
| additionalPCI-ToReleaseList-r17 | SEQUENCE |

(SIZE(1..maxNrofAdditionalPCI-r17)) OF AdditionalPCIIndex-r17
OPTIONAL, -- Need N

| | |
|---|---|
| unifiedTCI-StateType-r17 | ENUMERATED {separate, |
| joint} | OPTIONAL, -- Need R |

uplink-PowerControlToAddModList-r17 SEQUENCE (SIZE

| | |
|---|---|
| (1..maxUL-TCI-r17)) OF Uplink-powerControl-r17 | OPTIONAL, |

-- Need N
uplink-PowerControlToReleaseList-r17 SEQUENCE (SIZE

| | |
|---|---|
| (1..maxUL-TCI-r17)) OF Uplink-powerControlId-r17 | OPTIONAL, |

-- Need N

| | |
|---|---|
| sfnSchemePDCCH-r17 | ENUMERATED |
| {sfnSchemeA,sfnSchemeB} | OPTIONAL, |

-- Need R

| | |
|---|---|
| sfnSchemePDSCH-r17 | ENUMERATED |
| {sfnSchemeA,sfnSchemeB} | OPTIONAL |

-- Need R
}

1. Joint UL/DL mode: UL and DL are configured to share the same TCI configuration (in PDSCH-Config).

| | |
|---|---|
| dl-OrJoint-TCIStateList-r17 | CHOICE { |
| explicitlist | SEQUENCE |

```
{
      dl-orJoint-TCI-State-ToAddModList-r17
SEQUENCE (SIZE (1.. maxNrofTCI-States)) OF TCI-State
OPTIONAL, -- Need N
      dl-orJoint-TCI-State-ToReleaseList-r17
SEQUENCE (SIZE (1.. maxNrofTCI-States)) OF TCI-StateId
OPTIONAL -- Need N
    },
    unifiedTCI-StateRef-r17
ServingCellAndBWP-Id-r17
  }
OPTIONAL, -- Need R
```

2. Separate UL/DL mode: Separate TCI configurations are provided for UL and DL. A TCI state for DL may conform to a configuration in dl-OrJoint-TCIStateList-r17 (in PDSCH-Config), and a TCI state for UL may conform to ul-TCI-StateList-r17 (in BWP-UplinkDedicated).

| | |
|---|---|
| ul-TCI-StateList-r17 | CHOICE { |
| explicitlist | SEQUENCE { |
| ul-TCI-ToAddModList-r17 | SEQUENCE (SIZE |
| (1..maxUL-TCI-r17)) OF TCI-UL-State-r17 | OPTIONAL, -- |

Need N

| | |
|---|---|
| ul-TCI-ToReleaseList-r17 | SEQUENCE (SIZE |
| (1..maxUL-TCI-r17)) OF TCI-UL-State-Id-r17 | OPTIONAL -- |

Need N
},

| | |
|---|---|
| unifiedTCI-StateRef-r17 | ServingCellAndBWP-Id-r17 |

| | |
|---|---|
| } | OPTIONAL, -- Need R |

According to an embodiment, while RRC connected to serving cell 1, after the configuration on TRP 2-Cell 2 is provided, the UE may, in 457, perform L1 measurement on TRP 2-Cell 2 according to the received configuration and report a corresponding result to the serving cell (cell 1) 410. If it is determined, according to the measurement result, to be necessary to change to a specific beam (TCI state 2) 435 or 440 of TRP 2 (cell 2) 415, rather than maintaining the serving cell beam (TCI state 1) 425 or 430, the serving cell may, in 458, trigger beam change and indicate the beam change to the UE via L1/L2 signaling. The UE may perform beam changing to the specific beam (TCI state 2) 440 of TRP 2 (cell 2) 415 according to the indication, and may perform physical channel configuration and higher-layer configuration operations associated with the configured beam. From this step, the UE may remain connected to the serving cell (cell 1) 410, but may perform data transmission and reception using a channel link of TRP 2 (cell 2) 415 (e.g., PDCCH/PDSCH reception and physical uplink control channel (PUCCH)/physical uplink shared channel (PUSCH) transmission). That is, transmission and reception on a common control channel may be performed via the serving cell (cell 1) 410. Afterward, the UE may perform an L3 measurement operation 459 according to the measurement configuration configured in the independent serving cell, and may, in 460, receive a handover command message from the serving base station (cell 1) and perform serving cell changing to cell 2. Via the technique 455, the UE may perform, while connected to the serving cell, data transmission and reception to and from specific TRP 2 of cell 2 supporting L1/L2-based mobility, and may subsequently use the corresponding beam even after the handover.

Hereinafter, the RRC configuration for the configurations and operations related to L1 measurement and reporting in step 457 will be described in detail. This content may also be basically applied to the following embodiments of the disclosure, and an enhanced technique may be added in later embodiments.

1. L1 Measurement Configuration (CSI-ResourceConfig, Configured within ServingCellConfig Information Element (IE) in Serving Cell)
Measurement required CSI-reference signal (RS)/synchronization signal block (SSB) resources and resource pools (non-zero power (nzp)-CSI-RS, csi-interference measurement (IM), and csi-SSB)
Measurement required CSI-RS/SSB resource configuration (aperiodic and semi-persistent) and triggering configuration
When a CSI-RS resource refers to an SSB resource, additional PCI information is provided to enable L1 measurement from neighboring cells (up to 7 neighboring cells (PCIs) can be added in one serving cell).

| | |
|---|---|
| CSI-ResourceConfig ::= | SEQUENCE { |
| csi-ResouceConfigID | CSI-ResourceConfigId, |
| csi-RS-ResourceSetList | CHOICE { |
| nzp-CSI-RS-SSB | SEQUENCE { |

```
      nzp-CSI-RS-ResourceSetList SEQUENCE (SIZE
(1..maxNrofNZP-CSI-RS-ResourceSetsPerConfig)) OF NZP-CSI-RS-
ResourceSetId
OPTIONAL, -- Need R
      csi-SSB-ResourceSetList SEQUENCE (SIZE
(1..maxNrofCSI-SSB-ResourceSetsPerConfig)) OF CSI-SSB-
ResourceSetId OPTIONAL -- Need R
    },
    csi-IM-ResourceSetList SEQUENCE (SIZE
(1..maxNrofCSI-IM-ResourceSetsPerConfig)) OF CSI-IM-
ResourceSetId
  },
```

| | |
|---|---|
| bwp-Id | BWP-ID,\| |

```
  resourceType ENUMERATED { aperiodic,
semiPersistent, periodic },
  ...,
  [[
  csi-SSB-ResourceSetListExt-r17 CSI-SSB-ResourceSetId
OPTIONAL -- Need R
  ]]
}
```

| | |
|---|---|
| CSI-SSB-ResourceSet ::= | SEQUENCE { |
| csi-SSB-ResourceSetId | CSI-SSB-ResourceSetId, |

```
  csi-SSB-ResourceList SEQUENCE
(SIZE(1..maxNrofCSI-SSB-ResourcePerSet)) OF SSB-Index,
  ...,
  [[
  servingAdditionalPCIList-r17 SEQUENCE
(SIZE(1..maxNrofCSI-SSB-ResourcePerSet)) OF
ServingAddittionalPCIIndex-r17 OPTIONAL -- Need R
  ]]
}
ServingAdditionalPCIIndex-r17 ::=
INTEGER(0..maxNrofAdditionalPCI-r17)
```

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, |

ms20, ms40, ms80, ms160, spare2, spare1 },

| | |
|---|---|
| ssb-PositionsInBurst-r17 | CHOICE { |
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ss-PBCH-BlockPower-r17 | INTEGER (−60..50) |

}

2. L1 Reporting Configuration (Configured within ServingCellConfig IE in Serving Cell)
Report type: Periodic report, semi-periodic report via PUCCH, semi-periodic report via PUSCH, and aperiodic report via PUSCH (periodic, semi-persistent for PUCCH, semi-persistent for PUSCH, and aperiodic)
Report quantity
Other configurations required for reporting

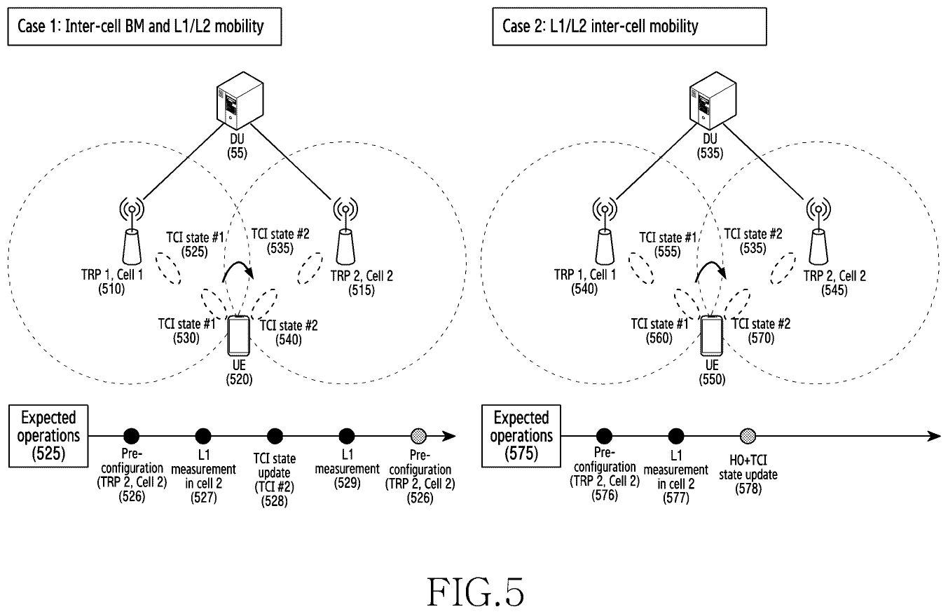

FIG. 5 illustrates a scenario in which a UE transmits and receives data by changing a serving cell and a beam to a TRP of a cell supporting an L1/L2-based beam change, according to an embodiment of the disclosure. Referring to FIG. 5, a case where multiple cells (TRP1-Cell1 and TRP2-Cell2) 510, 515, 540, and 545 exist within a single distributed unit (DU) 505 or 535 is illustrated, but various embodiments of the disclosure are also applicable to a case of inter-DU (e.g., respective DUs constitute one TRP-Cell).

Unlike the existing UE beam change procedures 445 and 445 described in FIG. 4, enhanced beam change techniques 525 and 575 according to various embodiments of the disclosure are as follows.
1. Embodiment 1 525: After performing inter-cell beam management (change) operation, performing L1/L2 handover
2. Embodiment 2 575: Directly performing L1/L2 handover

First, to describe overall operations of embodiment 1, a UE 520 may receive 526, from a serving cell 510 via RRC configuration information, common configuration and dedicated configuration information for the additional cell (TRP 2-Cell 2) 515 having a PCI different from that of the serving cell. For example, configuration information corresponding to ServingCellID or candidateCellID (cell ID associated with PCI), ServingCellConfigCommon, and ServingCellConfig may be provided in advance. The configuration information may be provided in a pre-configuration form in the RRC configuration, and may include configuration information for multiple cells. In addition, the configuration may include all configuration information (e.g., cell configuration, bearer configuration, security key configuration, etc.) applied when the UE moves (for example, performs handover) to the corresponding cell. In addition, the configuration may include an enhanced configuration by referring to the unified TCI state configuration described in step 456 of FIG. 4 and the configurations related to L1 measurement and reporting. According to an embodiment, for subsequent LTM (L1/L2 triggered mobility), the enhanced unified TCI state configuration and L1 measurement and reporting configurations may be transmitted to the UE, and hereinafter, detailed descriptions related thereto will be provided.

According to an embodiment, while RRC connected to serving cell 1, after the configuration on TRP 2-Cell 2 515 is provided, the UE may, in step 527, perform L1 measurement on TRP 2-Cell 2 515 according to the received configuration, and report a corresponding result to the serving cell (cell 1) 510. If it is determined, according to the measurement result, to be necessary to change to a specific beam (TCI state 2) 540 of TRP 2 (cell 2) 515, rather than maintaining the serving cell beam (TCI state 1) 525, the serving cell may, in step 528, trigger beam change and indicate the beam change to the UE via L1/L2 signaling. The UE may perform beam changing to TRP 2 (cell 2) 515 via the indication, and perform data transmission and reception via TRP 2 (cell 2) 515. At this time, no serving cell change is performed, and the UE may still be RRC connected to the serving cell (cell 1) 510. Afterward, the UE may still perform L1 measurement 529 for TRP 2-Cell 2 515, and report a result thereof to the serving cell (cell 1) 510. If the L1 measurement reported by the UE satisfies a triggering condition (detailed operations will be described in detail below) for handover to TRP 2-Cell 2 515, the serving cell (cell 1) 510 may indicate handover to the UE. According to an embodiment, the indication may be an L1/L2 message. For example, a MAC control element (CE) or downlink control information (DCI) may include an indicator indicating handover.

To describe overall operations of embodiment 2, the UE may receive 576, from the serving cell 540 via RRC configuration information, common configuration and dedicated configuration information for the additional cell (TRP 2-Cell 2) 545 having the PCI different from that of the serving cell. For example, ServingCellID or candidateCellID (cell ID associated with PCI) and configuration information corresponding to a candidate LTM cell may be provided in advance. The configuration information may be provided in a pre-configuration form in the RRC configuration, and may include configuration information for multiple cells. In addition, according to an embodiment, the configuration may include all configuration information (cell configuration, bearer configuration, security key configuration, etc.) applied when the UE moves (for example, performs handover) to the corresponding cell. In addition, in the configuration, the unified TCI state configuration described in step 456 of FIG. 4 and the configurations related to L1 measurement and reporting may be modified and included to support subsequent LTM. Hereinafter, L1 measurement and reporting and TCI state configurations according to various embodiments of the disclosure will be described in detail.

After the configuration on TRP 2-Cell 2 545 is provided while RRC connected to serving cell 1, the UE may, in step 577, perform L1 measurement on TRP 2-Cell 2 545 according to the received configuration, and report a corresponding result to the serving cell (cell 1) 540. If it is determined, according to the measurement result, to be necessary to change to a specific beam (TCI state 2) 570 of TRP 2 (cell 2) 545 and perform handover at the same time, rather than maintaining the serving cell beam (TCI state 1) 545, the serving cell may, in step 578, trigger beam change and handover and indicate the beam change and handover to the UE via L1/L2 signaling. The UE may perform beam changing and handover to TRP 2 (cell 2) 515 at the same time via the indication, and perform data transmission and reception via TRP 2 (cell 2) 515. In this case, the UE may apply the configuration information, which is preconfigured in step 576, to the target cell to which handover is performed. In this step, according to whether uplink synchronization needs to be matched, the UE may perform random access, or random access for the target cell may be omitted. Detailed operations related to the descriptions above will be illustrated in detail below.

According to an embodiment, as described above, according to various embodiments of the disclosure, the unified TCI state configuration and L1 measurement and reporting configurations for neighboring candidate LTM cells to support subsequent LTM will be described in detail. As described in FIG. 4, in the existing scheme, L1 measurement resource configuration for cells required to be measured may be provided in CSI-ResourceConfig in ServingCellConfig IE in the serving cell configuration. In particular, in order to indicate resources for neighboring cells, a PCI of a cell for which a corresponding L1 measurement resource has been configured may be indicated in servingAdditionalPCIList.

According to various embodiments of the disclosure, in order to support subsequent L1/L2 triggered mobility (LTM), a method of configuring L1 measurement information for neighboring candidate cells for LTM, a configuration method for reporting of configured L1 measurement information by the UE, etc. will be described in detail. Hereinafter, according to various embodiments, the unified TCI state configuration may be equally applied and configured to positions in which L1 measurement resources are configured. However, the disclosure is not limited thereto, and it is apparent that the disclosure can be illustrated without this description.

### 1. Issue 1: Method of SSB-Based L1 Measurement Resource Configuration for Neighboring Cells

First L1 measurement resource configuration method: In addition to the serving cell configuration, an L1 measurement resource configuration for LTM candidate cells may be provided as a separate and independent configuration. According to various embodiments of the disclosure, the L1 measurement resource configuration for LTM candidate cells may include the following information elements (IEs), but the disclosure is not limited thereto, and various IEs may be included.
A cell index indicating an LTM candidate cell (a PCI or a logical LTM candidate cell configuration index)
SSB measurement timing configuration (SMTC) for L1 measurement
A time and frequency resource configuration of L1 measurement resources
Sub-carrier spacing (SCS) of L1 measurement resources

According to an embodiment, the following ASN.1 (e.g., ltm-L1-measConfig) may be referenced.

LTM-CandidateConfig-r18 ::= SEQUENCE {

| | |
|---|---|
| lte-ReferenceConfiguration-r18 | OCTET STRING |
| (CONTAINING RRCReconfiguration), | OPTIONAL, |

-- Cond FirstLTM-Candidate

| | |
|---|---|
| ltm-CandidateToReleaseList-r18 | LTM- |

CandidateToReleaseList-r18
OPTIONAL, -- Need N

| | |
|---|---|
| ltm-CandidateToAddModList-r18 | LTM- |

CandidateToAddModList-r18
OPTIONAL, -- Need N

| | |
|---|---|
| ltm-CandidateResetL2-List-r18 | SetupRelease { LTM- |
| CandidateResetL2-List-r18 } | OPTIONAL -- Need |

M

| | |
|---|---|
| ltm-L1-measConfig | SetupRelease { LTM- |
| L1-measConfig-r18 } | OPTIONAL -- Need M |

...
}

Second L1 measurement resource configuration method: An L1 measurement resource configuration for LTM candidate cells may be provided via an L1 measurement configuration (CSI-ResourceConfig) that is configured within a serving cell configuration in a reference cell configuration.

According to an embodiment, since the reference cell configuration is configuration information commonly applied to multiple LTM candidate cells, when the L1 measurement resource configuration applied to the subsequent LTM operation is provided within the specific serving cell configuration of the reference cell, an existing structure for configuring L1 measurement resources may be reused so that subsequent LTM may be supported with less signaling overhead.

According to an embodiment, after LTM execution or if the L1 measurement resource configuration needs to be changed, the reference cell configuration may be changed/modified via RRC reconfiguration.

The reference cell configuration may include the following configuration information, and additionally, in order to facilitate applying a delta configuration, the L1 measurement resources applied to LTM candidate cells may be configured in the form of a list. For example, the reference cell configuration may use an AddMod/Release structure to manage the L1 measurement resources.
A cell index indicating an LTM candidate cell (a PCI or a logical LTM candidate cell configuration index)
SSB measurement timing configuration (SMTC) for L1 measurement
A time and frequency resource configuration of L1 measurement resources
Sub-carrier spacing (SCS) of L1 measurement resources

According to an embodiment, the following ASN.1 (for example, configured by applying CSI-ResourceConfig in ServingCellConfig IE in lte-ReferenceConfiguration) may be referenced.

LTM-CandidateConfig-r18 ::= SEQUENCE {

| | |
|---|---|
| lte-ReferenceConfiguration-r18 | OCTET STRING |
| (CONTAINING RRCReconfiguration), | OPTIONAL, |

-- Cond FirstLTM-Candidate

| | |
|---|---|
| ltm-CandidateToReleaseList-r18 | LTM- |

CandidateToReleaseList-r18
OPTIONAL, -- Need N

| | |
|---|---|
| ltm-CandidateToAddModList-r18 | LTM- |

CandidatetoAddModList-r18
OPTIONAL, -- Need N

| | |
|---|---|
| ltm-CandidateResetL2-List-r18 | SetupRelease { LTM- |
| CandidatekesetL2-List-r18 } | OPTIONAL -- Need |

M
...
}

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE |
| (1..maxNrofNZP-CSI-RS-ResourceSetPerConfig)) | OF NZP-CSI-RS- |

```
  ResourceSetId
  OPTIONAL, -- Need R
```

| | |
|---|---|
| csi-SSB-ResourceSetList | SEQUENCE (SIZE |
| (1..maxNrofCSI-IM-ResourceSetsPerConfig)) | OF CSI-SSB- |

```
  ResourceSetID OPTIONAL -- Need R
        },
```

| | |
|---|---|
| tsi-IM-ResourceSetList | SEQUENCE (SIZE |
| (1..maxNrofCSI-IM-ResourceSetsPerConfig)) | OF CSI-IM- |

```
  ResourceSetId
      },
```

| | |
|---|---|
| bwp-Id | BWP-Id, |
| resourceType | ENUMRATED { aperiodic, |

```
  semiPersistent, periodic },
      ...,
      [[
```

| | |
|---|---|
| csi-SSB-ResourceSetListExt-r17 | CSI-SSB-ResourceSetId |

```
  OPTIONAL -- Need R
      ]]
  }
```

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE |

```
  (SIZE(1..maxNrofCSI-SSB-ResourcePerSet)) OF SSB-Index,
      ...,
      [[
```

| | |
|---|---|
| servingAdditionalPCIList-r17 | SEQUENCE |

```
  (SIZE(1..maxNrofCSI-SSB-ResourcePerSet)) OF
  ServingAdditionalPCIIndex-r17 OPTIONAL -- Need R
      ]]
  }
```

| | |
|---|---|
| ServingAdditionalPCIIndex-r17 | ::= |

INTEGER(0..maxNrofAdditionalPCI-r17)

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, |

ms20, ms40, ms80, ms160, spare, spare1 },

| | |
|---|---|
| ssb-PositionsInBurst-r17 | CHOICE { |
| shortBITMAP | BIT STRING (SIZE (4)), |
| mediumBitmap | BIT STRING (SIZE (8)), |
| longBITMAP | BIT STRING (SIZE (64)) |

},

| | |
|---|---|
| ss-PBCH-BlockPower-r17 | INTEGER (−60..50) |

}

### 2. Issue 2: Method of SSB-Based L1 Measurement Resource Reporting for Neighboring Cells

First L1 measurement reporting configuration method: A configuration that enables reporting of the aforementioned configured L1 measurement resources may be provided in the current serving cell configuration (for example, the configuration may be provided via a serving cell configuration for receiving L1 measurement values for LTM candidate cells). According to an embodiment, in order to support L1 measurement value reporting for candidate cells in subsequent LTM and provide an L1 measurement reporting configuration in a corresponding cell after LTM is performed one time (e.g., handover), the L1 measurement reporting configuration may be provided via the serving cell configuration also in the LTM candidate cells.

According to an embodiment, inter-node coordination may be required to share L1 measurement resource and reporting configurations between the current serving cell and the LTM candidate cells.

For example, in the L1 measurement reporting configuration in the current serving cell, an L1 measurement report for the current LTM is provided, and after LTM is performed within each serving cell configuration of the LTM candidate cells, an L1 measurement reporting configuration applicable when a corresponding candidate cell becomes a serving cell may be transferred to the UE.

If the L1 measurement reporting configuration needs to be changed, each LTM candidate cell configuration may be updated via an RRC reconfiguration. To this end, inter-node coordination may be performed between the current serving cell and the LTM candidate cells.

Second L1 measurement reporting configuration method: A configuration that enables reporting of the aforementioned configured L1 measurement resources may be provided in the current serving cell configuration (for example, a configuration that enables reporting of L1 measurement resources may be provided in a serving cell configuration for receiving L1 measurement values for LTM candidate cells). According to an embodiment, in order to support L1 measurement value reporting for candidate cells in subsequent LTM, after LTM is performed one time (e.g., handover), in order to provide an L1 measurement reporting configuration in a corresponding cell, the L1 measurement reporting configuration may be provided within a serving cell configuration in a reference cell configuration.

According to an embodiment, a procedure of including the L1 measurement reporting configuration in the reference cell configuration via inter-node coordination for sharing L1 measurement resources and reporting configurations between the serving cell and the LTM candidate cells may be required.

For example, in the L1 measurement reporting configuration in the current serving cell, an L1 measurement report for the current LTM may be provided, and after LTM is performed within each serving cell configuration of the LTM candidate cells, the L1 measurement reporting configuration in the reference cell configuration may be applied as an L1 measurement reporting configuration applicable when a specific LTM candidate cell becomes a serving cell.

If the L1 measurement reporting configuration needs to be changed, each LTM reference cell configuration may be updated via an RRC reconfiguration. To this end, inter-node coordination may be performed between the current serving cell and the LTM candidate cells.

In the following embodiments, in relation to the methods of SSB-based L1 measurement resource configuration and SSB-based L1 measurement resource reporting for neighboring cells, descriptions will be provided for the overall operations to which the specific methods proposed in the disclosure described above are applied.

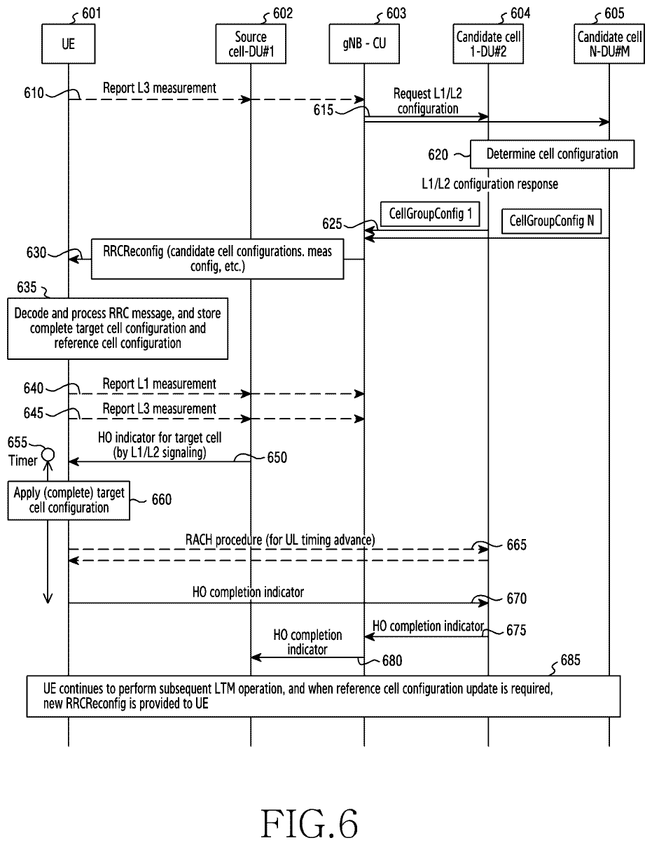

FIG. 6 illustrates a signal flow for supporting a subsequent L1/L2-based handover (L1/L2 triggered mobility (LTM)) operation, according to an embodiment of the disclosure.

According to an embodiment, a UE 601 in an RRC connected state may perform data transmission and reception to and from source cell 1 602. In step 610, the UE may transfer Layer 3 measurement values for a serving cell and neighboring cells to source cell 1 602 according to configured Layer 3 measurement and reporting. In this case, actual measurement values may be transferred to a base station CU 603. This is because the base station CU 603 is responsible for RRC message processing and determines mobility.

In step 615, the base station CU 603 may generate a message (e.g., an L1/L2 config request message, a HandoverPreparationInformation message, or a new message) for requesting configuration information for L1/L2-based handover, and transfer the message to neighboring LTM candidate cells 604 and 605 via an F1 interface according to the measurement value report received from the UE. Referring to FIG. 6, the candidate cells are illustrated in association with DUs. However, the disclosure is not limited thereto, and the candidate cells and DUs may be mapped 1:1, or multiple candidate cells may be included in one DU. According to an embodiment, the message for requesting configuration information for L1/L2-based handover may also include an existing handover request message, a UE context request message, a UE context modification request message, etc., or may include a new F1 or Xn message. The message for requesting configuration information for L1/L2-based handover may request, from the neighboring cells, acknowledgment of determination as L1/L2-based handover candidate cells, and concurrently request RRC configuration information applied when L1/L2-based handover is performed to a corresponding cell. In addition, the message may also include information for requesting L1 measurement resource and reporting configurations for LTM candidate cells according to various embodiments of the disclosure. The request for L1 measurement resource and reporting configurations may be performed for each candidate cell. Referring to FIG. 6, step 615 is illustrated as a single procedure, but is not limited thereto, and the operation may also be performed based on inter-node coordination via multiple procedures.

According to an embodiment, although not illustrated in the drawing, an inter-node coordination procedure that may be performed in this step for L1 measurement resource and reporting configurations are as follows.
Step 1: Receiving L1 measurement resource configurations from the LTM candidate cells.
Step 2: The source base station CU 603 transfers L1 measurement resource configurations for supporting subsequent LTM to the respective candidate cells via the collected L1 measurement resource configurations for the respective candidate cells (e.g., the first L1 measurement resource configuration method or the second L1 measurement resource configuration method).
Step 3: The source base station CU 603 requests and receives the L1 measurement reporting configurations from the LTM candidate cells.
Step 4: Transferring the LTM-related configuration to the UE (e.g., including an L1 resource reporting configuration configured according to the first L1 measurement resource reporting method).

According to an embodiment, in this case, the source base station CU 603 may transfer source cell configuration information and separate reference cell configuration information to the neighboring LTM candidate cells 604 and 605. According to an embodiment, the message transmitted by the source base station CU 603 may include the L1 measurement resource configurations for subsequent LTM in the reference cell configuration information.

According to an embodiment, the reference cell configuration information transferred by the source base station CU 603 to the respective candidate cells 604 and 605 may include configuration information (common configuration) applicable in common to multiple target candidate cells in order to reduce signaling overhead that may occur when the target candidate cells provide configuration information for LTM. The common configuration information may include measurement configuration, bearer configuration, or, for cells belonging to the same CellGroup, configurations configured at a CellGroup level (e.g., MAC-CellGroupConfig, RLC bearer configuration, SCell configuration, etc.). If the source base station CU 603 identifies the configuration information for each candidate cell 604 or 605, or there is a procedure of identifying the same, the reference cell configuration may be determined via a separate procedure for obtaining the reference cell configuration information, etc. The source base station CU 603 transfers the reference cell configuration to each candidate cells 604 or 605 in order to enable application of a delta configuration (e.g., a method of configuring a complete configuration by applying a configuration added on top of the reference cell configuration, or a method of configuring a complete configuration after overriding and applying a configuration in a target cell based on the reference cell configuration) by allowing each candidate cell to transfer, to the source base station CU 603, only configuration information added based on the reference cell configuration. This may be subsequently transferred as is to the UE, thereby reducing RRC message signaling transferred to the UE.

According to an embodiment, in addition, when the source base station CU 603 transfers the reference cell configuration to each candidate cell 604 or 605, if the reference cell configuration can be omitted, the candidate cell configuration may be provided as a complete RRC configuration. The RRC configuration information (CellGroupConfig 1, . . . , CellGroupConfig N) applied when L1/L2-based handover is performed may be transferred at one of a cell group level or an RRC message level. As described above, the message 615 for requesting configuration information for L1/L2-based handover may be transferred while including the reference cell information and configuration, and may include at least one of indicators indicating to apply a delta configuration to the reference cell configuration information or the configuration information for L1/L2-based handover, and transfers the same to the neighboring candidate cells 604 and 605. The indicator may be requested for each cell or may be requested in common for all cells.

In step 620, the neighboring candidate cells 604 and 605 having received the message for requesting configuration information for L1/L2-based handover may generate configuration information of each neighboring candidate cell when L1/L2-based handover has been applied, based on the transferred configuration information of the reference cell by either using the delta configuration or not applying the delta configuration.

In step 625, each neighboring candidate cell 604 or 605 may include the generated configuration information for L1/L2-based handover in a configuration information response message (L1/L2 config response message) for L1/L2-based handover, and transfer the response message to the base station CU 603.

In step 630, the base station CU 603 may transfer, to the source cell 602, an RRC message generated based on the configuration information received from each candidate cell, and the source cell 602 may transfer the received message to the UE. The RRC message may include configuration information (Pre-Config1, . . . , Pre-ConfigN) for neighboring candidate cells to which L1/L2-based handover (LTM) is applied. Pre-Config included in the RRC message may include information on CellGroupConfig configurations received from the LTM candidate cells in step 625, and bearer configurations and Layer 3 (L3) measurement configurations for the LTM candidate cells, which are generated by the base station.

In step 635, the UE having received the RRC message may decode and process the RRC message. The processing procedure performed by the UE may include ASN.1 decoding and validity determination for the received message, a method of storing or managing configuration details, and the like. In addition, the UE may store, as complete configuration information in a buffer (e.g., memory) of the UE, the LTM configuration information for each candidate cell decoded in step 635, and at the same time, the UE may also store and manage the received reference cell configuration information in the buffer (e.g., memory) of the UE. According to an embodiment, the reference cell configuration information may be omitted from the RRC message (or the configuration information for each LTM candidate cell) in step 630. In this case, the UE may identify that there is no reference cell configuration information, and may determine and store, as complete configuration information, the received configuration information for LTM target candidate cells. In this case, the reference cell configuration information may not be separately stored (e.g., operating as empty). For example, no delta configuration may be applied.

In step 640, the UE may perform Layer 1 (L1) measurement and reporting for each neighboring candidate cell, and may also concurrently perform L3 measurement and reporting in step 645 according to the received configurations.

In step 650, the source cell having received the L1 measurement report may determine handover based on a corresponding measurement value, and indicate the UE to perform L1/L2 handover. In step 650, a MAC CE and DCI including a handover indicator may be used as L1/L2 signaling. The L1 measurement value transfer for determining L1/L2 handover and the handover determination in steps 640 and 650 may be performed by the source cell (DU) or the source base station CU. If the base station CU makes all determinations, the source cell may transfer, to the base station CU, the L1 measurement value received from the UE, and transfer L1/L2 signaling to the UE according to the handover determination indication of the base station CU. However, if the source cell makes a final determination, the source cell may, without transferring the received L1 measurement value to the base station, determine handover on its own according to a measurement value reference (e.g., a threshold value or a measurement value range) for handover determination for each neighboring candidate cell, the reference being received from the previous base station, and accordingly, the source cell may transfer L1/L2 signaling to the UE.

In step 655, when the L1/L2 handover indication is transferred to the UE, the UE may start a handover procedure and drive a timer for L1/L2 handover. The timer may be a newly configured timer for LTM, or an existing T304 timer may be reused.

In step 660, the UE may apply the configuration on the target cell to which L1/L2 handover is applied. For example, the UE may replace the current configuration with the complete configuration information for the indicated LTM target cell, which is stored previously in the UE. This may be one of the LTM neighboring candidate cell configurations previously received in step 630, and may be a configuration stored in the UE.

In step 665, according to the applied configuration, the UE may perform random access when random access is required for the target cell, or when random access is neither indicated nor required (for example, when uplink synchronization has already been performed or configured), a random-access procedure may be omitted.

In step 670, the UE may perform a handover completion procedure with the target cell. The handover completion procedure may be a handover completion procedure for LTM. The procedure may vary according to a handover completion indication method. In addition, if the configuration of the target cell is received at an RRC message level, the procedure may be a procedure of transferring an RRCReconfigurationComplete message. However, if a cell level or cell group level configuration is received, the procedure may be replaced with a new handover completion indication message (e.g., new RRC message or MAC CE).

In addition, since this scenario considers application to intra-CU, the target cell (DU) 604 having received the handover completion message may transfer the received message to the base station CU 603 in step 675. In this case, the handover completion message received via the F1 interface may be transferred as it is, or the target cell 604 may reprocess the message based on the received information and transfer the same.

In step 680, the base station CU 603 may transfer information on handover completion to the source cell 602, and indicate to release UE context.

As illustrated in step 685, various embodiments of the disclosure may support subsequent LTM operations. The subsequent LTM operations may include that the LTM configuration information (e.g., configurations for the target candidate cells, the reference cell configuration information, etc.) received by the UE in step 630 is stored as it is in the UE, and unless the LTM configuration information is changed/released/added via a separate RRC configuration, the UE continues to perform the LTM procedure. If it is necessary to update the reference cell configuration information, new RRC configuration information may be transferred to the UE, and the subsequent LTM operations may be performed. For example, all or some of the aforementioned procedures described in the drawing may be re-triggered and performed.

According to an embodiment, when the UE is provided with the reference cell configuration information in step 630, the UE may store the same in the UE buffer, and if there is no separate update for configuration, the UE may use the configuration as the reference cell configuration information even after performing LTM (step 650) (for example, the UE may apply reference cell configuration and LTM candidate configuration values stored in subsequent LTM). In addition, in step 630, if the UE has failed to be provided with the reference cell configuration information in an RRC connected state, the UE may, according to some of the UE operation options described above, store the reference cell configuration as empty, or may store, as the reference cell configuration information, configuration information for the source cell (PCell) from which the LTM configuration information has been received.

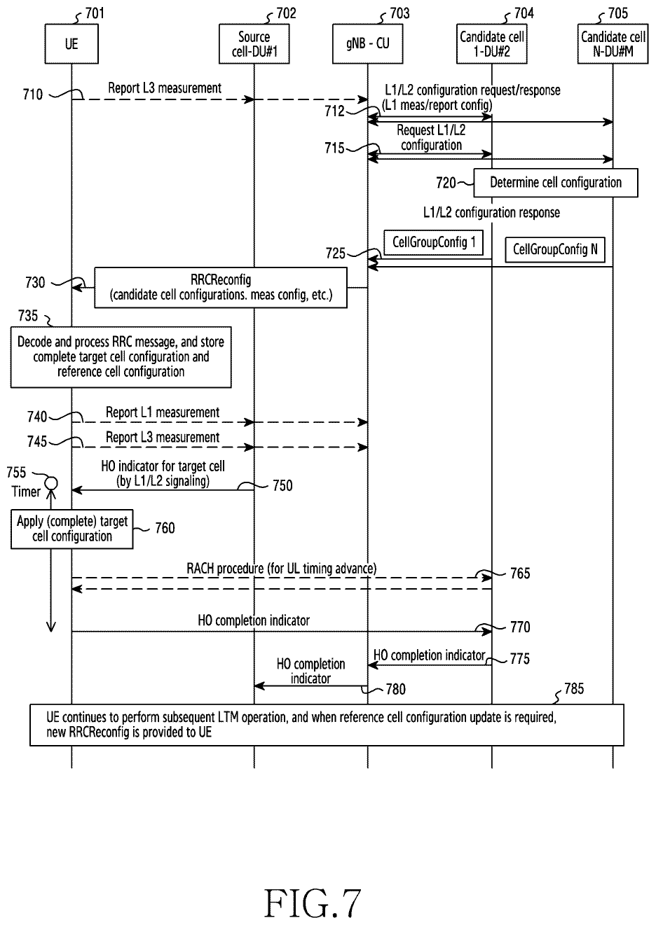

FIG. 7 illustrates another L1 signal flow for supporting a subsequent L1/L2-based handover (LTM) operation, according to an embodiment of the disclosure.

According to an embodiment, a UE 701 in an RRC connected state may perform data transmission and reception to and from source cell 1 702. In step 710, the UE may transfer Layer 3 measurement values for a serving cell and neighboring cells to source cell 1 702 according to configured Layer 3 measurement and reporting. In this case, actual measurement values may be transferred to a base station CU 703. This is because the base station CU 703 is responsible for RRC message processing and determines mobility.

In steps 712 and 715, the base station CU 703 may generate a message (e.g., an L1/L2 config request message, a HandoverPreparationInformation message, or a new message) for requesting configuration information for L1/L2-based handover, and transfer the message to neighboring LTM candidate cells 704 and 705 via an F1 interface according to the measurement value report received from the UE. Referring to FIG. 7, the candidate cells are illustrated in association with DUs. However, the disclosure is not limited thereto, and the candidate cells and DUs may be mapped 1:1, or multiple candidate cells may be included in one DU. According to an embodiment, the message for requesting configuration information for L1/L2-based handover may also include an existing handover request message, a UE context request message, a UE context modification request message, etc., and may include a new F1 or Xn message. The message for requesting configuration information for L1/L2-based handover may request, from the neighboring cells, acknowledgment of determination as L1/L2-based handover candidate cells, and concurrently request RRC configuration information applied when L1/L2-based handover is performed to a corresponding cell. In addition, the message may also include information for requesting L1 measurement resource and reporting configurations for LTM candidate cells according to various embodiments of the disclosure. The request for L1 measurement resource and reporting configurations may be performed for each candidate cell. Referring to FIG. 7, steps 712 and 715 may appear to be the same procedure. However, steps 712 and 715 are multiple procedures performed for different purposes for the second L1 measurement resource reporting method according to various embodiments of the disclosure, and inter-node coordination may be performed. For example, in step 712, L1 measurement resources may be shared, and step 712 may be a procedure for including the L1 measurement report as a reference cell configuration, and in step 715, the reference cell configuration including corresponding configurations may be transmitted together.

According to an embodiment, although not illustrated in the drawing, an inter-node coordination procedure that may be performed in this step for L1 measurement resource and reporting configurations are as follows.
Step 1: Receiving L1 measurement resource configurations from the LTM candidate cells.
Step 2: The source base station CU 703 transfers L1 measurement resource configurations for supporting subsequent LTM to the respective candidate cells via the collected L1 measurement resource configurations for the respective candidate cells (e.g., the first L1 measurement resource configuration method or the second L1 measurement resource configuration method).
Step 3: The source base station CU 703 requests and receives the L1 measurement reporting configurations from the LTM candidate cells (step 712).
Step 4: The source base station CU 703 requests LTM configuration information from the LTM candidate cells (step 715).
Step 5: Transferring the LTM-related configuration to the UE (e.g., including an L1 resource reporting configuration configured according to the second L1 measurement reporting configuration method)

According to an embodiment, in this case, the source base station CU 703 may transfer source cell configuration information and separate reference cell configuration information to the neighboring LTM candidate cells 704 and 705. According to an embodiment, the message transmitted by the source base station CU 703 may include the L1 measurement resource configurations for subsequent LTM in the reference cell configuration information.

According to an embodiment, the reference cell configuration information transferred by the source base station CU 703 to the respective candidate cells 704 and 705 may include configuration information (common configuration) applicable in common to multiple target candidate cells in order to reduce signaling overhead that may occur when the target candidate cells provide configuration information for LTM. The common configuration information may include measurement configuration, bearer configuration, or, for cells belonging to the same CellGroup, configurations configured at a CellGroup level (e.g., MAC-CellGroupConfig, RLC bearer configuration, SCell configuration, etc.). If the source base station CU 703 identifies the configuration information for each candidate cell 704 or 705, or there is a procedure of identifying the same, the reference cell configuration may be determined via a separate procedure for obtaining the reference cell configuration information, etc. The source base station CU 703 transfers the reference cell configuration to each candidate cells 704 or 705 in order to enable application of a delta configuration (e.g., a method of configuring a complete configuration by applying a configuration added on top of the reference cell configuration, or a method of configuring a complete configuration after overriding and applying a configuration in a target cell based on the reference cell configuration) by allowing each candidate cell to transfer, to the source base station CU 703, only configuration information added based on the reference cell configuration. This may be subsequently transferred as is to the UE, thereby reducing RRC message signaling transferred to the UE.

According to an embodiment, in addition, when the source base station CU 703 transfers the reference cell configuration to each candidate cell 704 or 705, if the reference cell configuration can be omitted, the candidate cell configuration may be provided as a complete RRC configuration. The RRC configuration information (CellGroupConfig 1, . . . , CellGroupConfig N) applied when L1/L2-based handover is performed may be transferred at one of a cell group level or an RRC message level. As described above, the message 715 for requesting configuration information for L1/L2-based handover may be transferred while including the reference cell information and configuration, and may include at least one of indicators indicating to apply a delta configuration to the reference cell configuration information or the configuration information for L1/L2-based handover, and transfers the same to the neighboring candidate cells 704 and 705. The indicator may be requested for each cell or may be requested in common for all cells.

In step 720, the neighboring candidate cells 704 and 705 having received the message for requesting configuration information for L1/L2-based handover may generate configuration information of each neighboring candidate cell when L1/L2-based handover has been applied, based on the transferred configuration information of the reference cell by either using the delta configuration or not applying the delta configuration.

In step 725, each neighboring candidate cell 704 or 705 may include the generated configuration information for L1/L2-based handover in a configuration information response message (L1/L2 config response message) for L1/L2-based handover, and transfer the response message to the base station CU 703.

In step 730, the base station CU 703 may transfer, to the source cell 702, an RRC message generated based on the configuration information received from each candidate cell, and the source cell 702 may transfer the received message to the UE. The RRC message may include configuration information (Pre-Config1, . . . , Pre-ConfigN) for neighboring candidate cells to which L1/L2-based handover (LTM) is applied. Pre-Config included in the RRC message may include information on CellGroupConfig configurations received from the LTM candidate cells in step 725, and bearer configurations and Layer 3 (L3) measurement configurations for the LTM candidate cells, which are generated by the base station.

In step 735, the UE having received the RRC message may decode and process the RRC message. The processing procedure performed by the UE may include ASN.1 decoding and validity determination for the received message, a method of storing or managing configuration details, and the like. In addition, the UE may store, as complete configuration information in a buffer (e.g., memory) of the UE, the LTM configuration information for each candidate cell decoded in step 735, and at the same time, the UE may also store and manage the received reference cell configuration information in the buffer (e.g., memory) of the UE. According to an embodiment, the reference cell configuration information may be omitted from the RRC message (or the configuration information for each LTM candidate cell) in step 730. In this case, the UE may identify that there is no reference cell configuration information, and may determine and store, as complete configuration information, the received configuration information for LTM target candidate cells. In this case, the reference cell configuration information may not be separately stored (e.g., operating as empty). For example, no delta configuration may be applied.

In step 740, the UE may perform Layer 1 (L1) measurement and reporting for each neighboring candidate cell, and may also concurrently perform L3 measurement and reporting in step 745 according to the configurations.

In step 750, the source cell having received the L1 measurement report may determine handover based on a corresponding measurement value, and indicate the UE to perform L1/L2 handover. In step 750, a MAC CE and DCI including a handover indicator may be used as L1/L2 signaling. The L1 measurement value transfer for determining L1/L2 handover and the handover determination in steps 740 and 750 may be performed by the source cell (DU) or the source base station CU. If the base station CU makes all determinations, the source cell may transfer, to the base station CU, the L1 measurement value received from the UE, and transfer L1/L2 signaling to the UE according to the handover determination indication of the base station CU. However, if the source cell makes a final determination, the source cell may, without transferring the received L1 measurement value to the base station, determine handover on its own according to a measurement value reference (e.g., a threshold value or a measurement value range) for handover determination for each neighboring candidate cell, the reference being received from the previous base station, and accordingly, the source cell may transfer L1/L2 signaling to the UE.

In step 755, when the L1/L2 handover indication is transferred to the UE, the UE may start a handover procedure and drive a timer for L1/L2 handover. The timer may be a newly configured timer for LTM, or an existing T304 timer may be reused.

In step 760, the UE may apply the configuration on the target cell to which L1/L2 handover is applied. For example, the UE may replace the current configuration with the complete configuration information for the indicated LTM target cell, which is stored previously in the UE. This may be one of the LTM neighboring candidate cell configurations previously received in step 730, and may be a configuration stored in the UE.

In step 765, according to the applied configuration, the UE may perform random access when random access is required for the target cell, and when random access is neither indicated nor required (for example, when uplink synchronization has already been performed or configured), a random-access procedure may be omitted.

In step 770, the UE may perform a handover completion procedure with the target cell. The handover completion procedure may be a handover completion procedure for LTM. The procedure may vary according to a handover completion indication method. In addition, if the configuration of the target cell is received at an RRC message level, the procedure may be a procedure of transferring an RRCReconfigurationComplete message. However, if a cell level or cell group level configuration is received, the procedure may be replaced with a new handover completion indication message (e.g., new RRC message or MAC CE).

In addition, since this scenario considers application to intra-CU, the target cell (DU) 704 having received the handover completion message may transfer the received message to the base station CU 703 in step 775. In this case, the handover completion message received via the F1 interface may be transferred as it is, or the target cell 704 may reprocess the message based on the received information and transfer the same.

In step 780, the base station CU 703 may transfer information on handover completion to the source cell 702, and indicate to release UE context.

As illustrated in step 785, various embodiments of the disclosure may support subsequent LTM operations. The subsequent LTM operations may include that the LTM configuration information (e.g., configurations for the target candidate cells, the reference cell configuration information, etc.) received by the UE in step 730 is stored as it is in the UE, and unless the LTM configuration information is changed/released/added via a separate RRC configuration, the UE continues to perform the LTM procedure. If it is necessary to update the reference cell configuration information, new RRC configuration information may be transferred to the UE, and the subsequent LTM operations may be performed. For example, all or some of the aforementioned procedures described in the drawing may be re-triggered and performed.

According to an embodiment, when the UE is provided with the reference cell configuration information in step 730, the UE may store the same in the UE buffer, and if there is no separate update for configuration, the UE may use the configuration as the reference cell configuration information even after performing LTM (step 750) (for example, the UE may apply reference cell configuration and LTM candidate configuration values stored in subsequent LTM). In addition, in step 730, if the UE has failed to be provided with the reference cell configuration information in an RRC connected state, the UE may, according to some of the UE operation options described above, store the reference cell configuration as empty, or may store, as the reference cell configuration information, configuration information for the source cell (PCell) from which the LTM configuration information has been received.

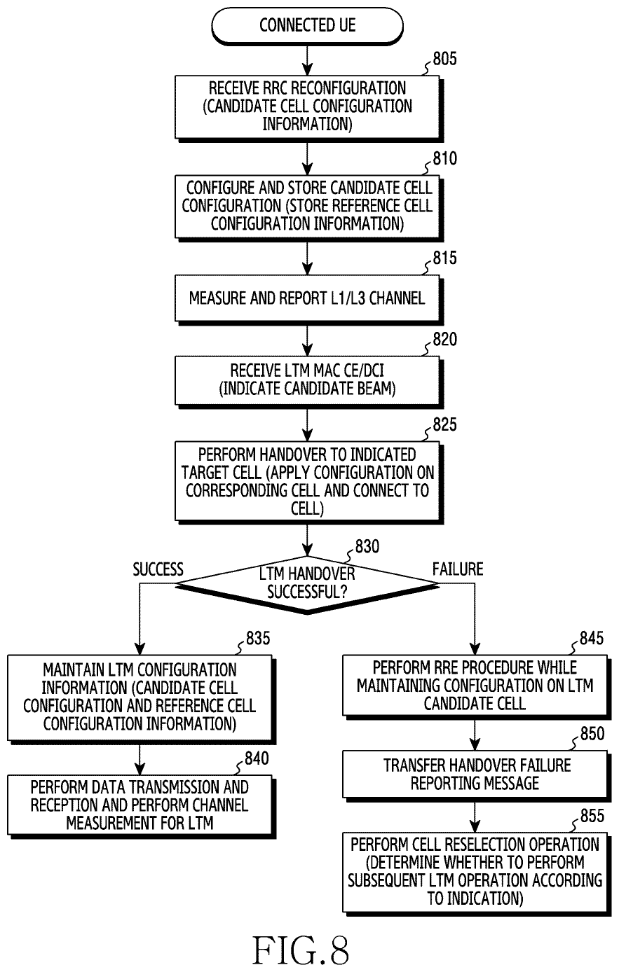

FIG. 8 illustrates an operation flow of a UE for performing L1/L2-based beam changing and handover, according to an embodiment of the disclosure. In particular, a UE operation according to various embodiments of the disclosure may be characterized by a method of performing L1 measurement and reporting according to L1 measurement resource and reporting configurations for subsequent LTM operations.

In step 805, a connected UE may receive, via an RRC reconfiguration message from a serving cell, configuration information related to neighboring cells, which is applied after L1/L2-based mobility is indicated. Specific configuration methods and details have been described in FIGS. 6 and 7. In addition, referring to FIG. 8, although omitted prior to RRC configuration information and not illustrated, the UE may have received a basic RRC configuration from a base station, and may perform an operation of reporting Layer 3 measurement values for neighboring cells. In particular, the configuration information in the LTM candidate cells, which is received in step 805 and applied after L1/L2-based mobility is indicated, may be transferred by applying a delta configuration based on a configuration for one reference cell. The UE may identify a reference cell and configuration information for the reference cell, which are previously identified or indicated via RRC configuration. Configurations for neighboring cells other than the reference cell have the reference cell configuration in common, and are transferred as additional configurations, so that signaling overhead may be reduced. In the configuration step described above, the UE may receive resource and reporting-related configuration information for L1 measurement on the LTM candidate cells. For detailed configuration methods, reference may be made to the aforementioned first L1 measurement resource configuration method/second L1 measurement resource configuration method and first L1 measurement reporting configuration method/second L1 measurement reporting configuration method.

In step 810, the UE may decode the received configurations for LTM candidate cells, based on the configuration of the reference cell, and may store and manage an actually applied complete configuration (e.g., an operation of storing a configuration, to which a delta configuration has been applied based on the reference cell, as a complete configuration by referring to the reference cell configuration) in a separate buffer and list. Alternatively, the UE may store and manage the received RRC configurations as they are in the buffer, without decoding the received configurations based on the reference cell, and storing and managing the actually applied configuration. As described with reference to FIG. 6, when the UE receives a configuration in which the reference cell configuration is omitted, the UE may identify that there is no reference cell configuration information, and may determine and store, as complete configuration information, the received configuration information for the LTM target candidate cells. In this case, the UE may not separately store reference cell configuration information (e.g., operating as empty). For example, no delta configuration may be applied. In this step, an advantage generated by the UE decoding the configurations for the neighboring cells based on the reference cell and storing an actually applied configuration may be that, when an actual L1/L2-based handover is indicated, the handover to a corresponding cell may be applied immediately, resulting in no additional delay.

In step 815, the UE may perform L1 measurement associated with the neighboring candidate cells while maintaining the connection to the serving cell, and may report corresponding measurement results to the serving cell according to the preconfigured L1 measurement reporting configuration method. In addition, independently of this operation, the UE may measure the neighboring cells according to an L3 measurement configuration, and report corresponding measurement results to the base station according to an L3 measurement reporting configuration. The serving cell may determine, based on the received measurement results, whether to perform beam change and whether to perform handover for the UE.

In step 820, if a change to a specific beam of the neighboring cells is determined to be necessary rather than a specific beam of the serving cell, the serving cell may indicate, via L1/L2 signaling, the handover and beam change for the UE. Referring to FIG. 8, the L1/L2 signaling may be a MAC CE and DCI, wherein the MAC CE may indicate information indicating both a specific beam of the neighboring cells and a change of the serving cell (e.g., a case where the MAC CE indicates only one beam), or the MAC CE may indicate multiple specific beams of an LTM target cell, and subsequently transmitted DCI may indicate a handover for which one of multiple beams of the neighboring cells, which are activated by the MAC CE, is selected.

In step 825, the UE may identify whether handover is indicated from the MAC CE and DCI signaling received in step 815, and perform an LTM handover operation. When the MAC CE and DCI indicate handover (e.g., a case where the MAC CE itself indicates handover, or the MAC CE activates multiple beams, and the DCI indicates handover while indicating one of the beams), the UE may perform handover to a cell associated with an indicated TCI state.

In step 830, when random access is successfully performed and the handover succeeds, the UE may also apply the configuration for the LTM target cell stored in step 810.

In step 835, the UE may maintain the previously stored LTM configuration information and reference cell configuration information.

In step 840, the UE may connect to the indicated LTM target cell, and perform data transmission and reception using the indicated beam. The UE may perform channel measurement reporting according to the LTM configuration, and may continue to perform subsequent LTM operations.

If the UE fails LTM handover in step 830, the UE may attempt to fallback to the previous source cell for connection in step 845. To this end, the UE may need to maintain the configuration information for the source cell even if LTM is triggered. In addition, even after the fallback to the source cell, the UE may maintain the LTM configuration information and reference cell configuration information for the LTM target cell. This may be to allow LTM to be re-triggered according to the existing configuration. If the fallback to the source cell cannot be completely performed, the UE may perform an RRC re-establishment procedure to reselect connectible cells. If a cell found via cell reselection is one of the LTM candidate cells, the UE may attempt connection by applying a preconfigured RRC configuration for the cell.

In step 850, the UE may generate a handover failure reporting message and transfer the message to the base station in the connected cell (e.g., the source cell or the target cell). The handover failure reporting message may include UEInformationResponse or another uplink RRC message. In addition, the UE may report this via a new MAC CE or uplink control information (UCI). Information included in the handover failure reporting message may include the following information.
An indicator indicating that handover has failed due to an LTM failure.
Information on a target cell to which LTM has been attempted and has failed: LTM cell configuration index or actual cell index (physical cell index (PCI)) information.

According to an embodiment, the source base station may identify, via the handover failure message reporting, that the LTM attempt has failed and fallback to the corresponding cell has been performed. In addition, if a cell found via cell reselection after an RRC re-establishment procedure is not one of the LTM candidate cells, the UE may maintain, in step 855, the LTM configuration information and reference cell configuration information stored in the cell. Alternatively, in this case, the UE may release the stored LTM-related configuration information and reference cell configuration information. Alternatively, the base station may explicitly specify an operation to the UE via configuration.

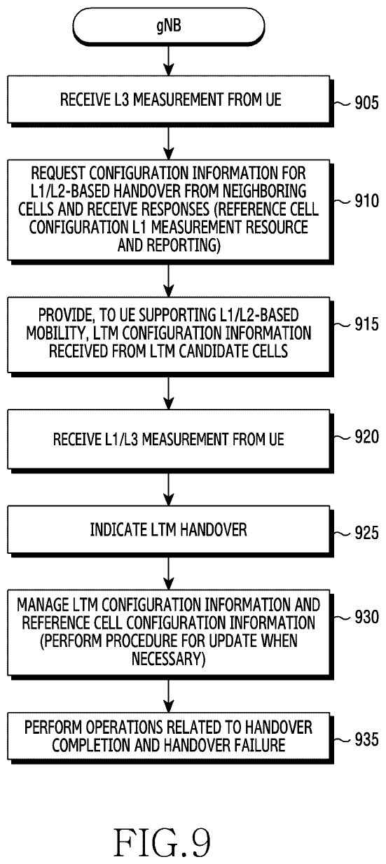

FIG. 9 illustrates an operation flow of a base station for performing L1/L2-based beam changing and handover, according to an embodiment of the disclosure.

In step 905, a base station may receive an L3 measurement value report from a UE, and may identify whether the UE requires handover, which cells are handover candidate cells, etc., based on measurement values of the UE with respect to neighboring frequencies and cells.

In step 910, the base station may request configuration information for L1/L2-based handover from the neighboring cells, and receive responses from the cells. In this step, the base station may transfer both configuration information for the current source cell and reference cell configuration information to the neighboring cells. The base station may receive, from the neighboring cells and LTM candidate cells, RRC configuration information to which a delta configuration is applied based on reference cell configuration information. In addition, in this step, inter-node coordination for L1 measurement resource and reporting configuration according to various embodiments of the disclosure may be performed. Reference may be made to the aforementioned first L1 measurement resource configuration method/second L1 measurement resource configuration method and first L1 measurement reporting configuration method/second L1 measurement reporting configuration method. Although omitted in this drawing, prior to this step, a configuration related to L3 measurement configuration and a basic RRC configuration may have been provided.

In step 915, the base station may transfer, to the connected UE, an RRC configuration message generated including the neighboring cell configuration information and L1 measurement resource/reporting configuration received in step 910. For example, the base station may transfer the configuration information of the neighboring cells, which is applied after L1/L2-based mobility is indicated, from a serving cell via an RRC reconfiguration message. Detailed configuration methods and content have been specifically described in FIGS. 6 and 7.

In step 920, the base station may receive a report on L1 and L3 measurement values from the UE, in which case, an L1 measurement value may indicate a neighboring cell (non-serving cell) supporting L1/L2-based mobility. The serving cell may determine, based on the received measurement result, whether to perform beam change and whether to perform handover for the UE. If the serving cell determines that a change from a specific beam of the serving cell to a specific beam of the neighbor cell is necessary, the serving cell may indicate, in step 925, LTM handover for the UE via L1/L2 signaling. The L1/L2 signaling may be a MAC CE or DCI, and may include information indicating a change to a specific beam of the neighboring cells. In addition, in this step, the existing handover may also be independently performed and indicated via the RRC message. This may occur because the base station and the serving cell determine LTM and Layer 3 handover independently of each other.

In step 935, when the base station receives a handover completion message from the UE, the base station may identify that the LTM operation has been successfully completed, and accordingly, may notify the previous source cell of the handover completion and request release of UE context. In addition, when the base station receives a handover failure reporting message including information indicating that the handover has failed, the base station may receive a message indicating that the UE has attempted to reconnect to the corresponding cell after the handover failure. The handover failure reporting message may include UEInformationResponse or another uplink RRC message. In addition, the base station may receive this via a new MAC CE or uplink control information (UCI). Information included in the handover failure reporting message may include the following information.
An indicator indicating that handover has failed due to an LTM failure.
Information on a target cell to which LTM has been attempted and has failed: LTM cell configuration index or actual cell index (physical cell index (PCI)) information.

The source base station may identify, via the handover failure message reporting, that the LTM attempt has failed and fallback to the corresponding cell has been performed.

According to embodiments of the disclosure, with respect to the L1 measurement reporting method described above, methods of triggering L1 measurement reporting via L1/L2 signaling for subsequent LTM operations are illustrated, and specific signaling and overall operation for each method are described.

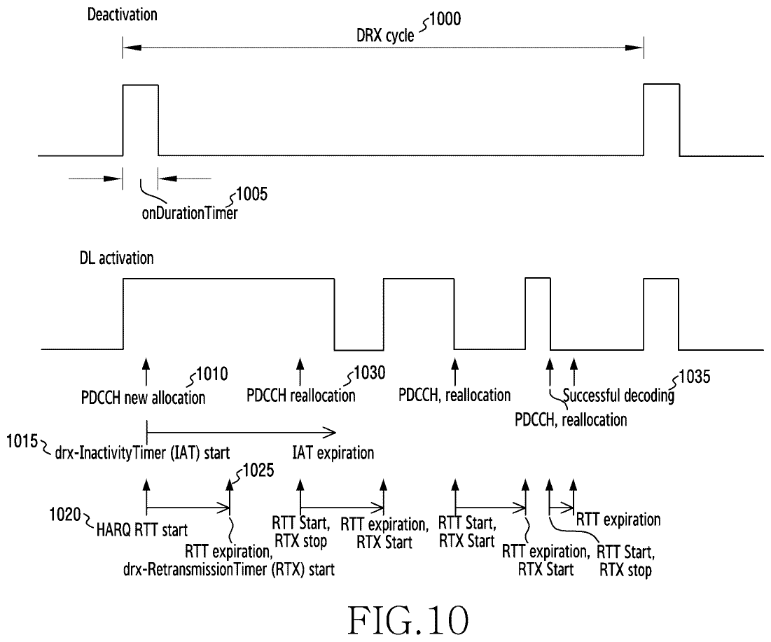

FIG. 10 illustrates a discontinuous reception (DRX) operation for a UE in a radio resource control (RRC) connected state, according to an embodiment of the disclosure.

According to an embodiment, DRX may also be defined in an RRC connected state, and an operation method may differ from DRX in an IDLE state. As described above, continuous monitoring of a PDCCH for a UE to acquire scheduling information may cause high power consumption.

According to an embodiment, a basic DRX operation may have a DRX cycle 1000, and a PDCCH may be monitored only for an on-duration 1005. In a connection mode, two values of the DRX cycle, long DRX and short DRX, may be configured. In a general case, a long DRX cycle is applied, and if necessary, a base station may trigger a short DRX cycle by using a MAC CE. After a predetermined time passes, the UE may change from a short DRX cycle to a long DRX cycle. Initial scheduling information of a specific UE is provided only in a predetermined PDCCH. Therefore, the UE may minimize power consumption by periodically monitoring only a predetermined PDCCH.

According to an embodiment, if scheduling information for a new packet is received 1010 via a PDCCH during the on-duration 1005, the UE may start a DRX inactivity timer 1015. The UE may maintain an active state during the DRX inactivity timer (for example, the UE may continue monitoring the PDCCH). In addition, the UE may start an HARQ round trip time (RTT) timer 1020. The HARQ RTT timer may be applied to prevent the UE from unnecessarily monitoring a PDCCH during the HARQ RTT time, and during a timer operation time, the UE does not need to perform PDCCH monitoring. However, while the DRX inactivity timer and the HARQ RTT timer are concurrently operating, the UE may continue PDCCH monitoring based on the DRX inactivity timer. When the HARQ RTT timer expires, a DRX retransmission timer 1025 may be started. While the DRX retransmission timer is operating, the UE may perform PDCCH monitoring. In general, during the operation time of the DRX retransmission timer, scheduling information for HARQ retransmission may be received 1030. When the scheduling information is received, the UE may immediately stop the DRX retransmission timer, and restart the HARQ RTT timer. The aforementioned operations may be continuously performed until the packet is successfully received 1035.

According to an embodiment, configuration information related to DRX operations in a connected mode may be transferred to the UE via an RRCConnectionReconfiguration message. In LTE, on-duration timer, DRX inactivity timer, and DRX retransmission timer may be defined as the number of PDCCH subframes. However, unlike in LTE, in NR, timer values may be configured not as the number of subframes, but in actual time units, such as ms, or in symbol and slot units. This is because, unlike LTE, in NR, according to sub-carrier spacing (SCS) configured in a bandwidth part (BWP), a unit for PDCCH monitoring is not a subframe, and this is to specify exact timing. After a timer starts, when the number of configured time intervals for PDCCH monitoring has elapsed, the timer may expire. In LTE frequency division duplex (FDD), all downlink subframes may belong to PDCCH subframes, and in time division duplex (TDD), downlink subframes and special subframes may correspond to PDCCH subframes. For example, in TDD, downlink subframes, uplink subframes, and special subframes may exist in the same frequency band. Among these, downlink subframes and special subframes may be regarded as PDCCH subframes. Likewise, in NR, a time interval for PDCCH monitoring may differ according to FDD and TDD, and may be configured in units of symbols or units of slots, instead of in units of subframes.

According to an embodiment, the base station may configure two states of long DRX and short DRX. The base station may use one of the two states in consideration of power preference indication information reported from the UE, UE mobility history information, characteristics of a configured data radio bearer (DRB), or the like. Transition between the two states may be performed based on whether a specific timer has expired or based on a specific MAC CE being transferred to the UE.

According to various embodiments of the disclosure, an overall structure related to configuration and reporting of channel state information (CSI) in a wireless communication system is described, wherein, basically, time/frequency resources for reporting CSI may be controlled by the base station. Parameters for CSI reporting may include channel quality indicator (CQI), precoding matrix indicator (PMI), CSI-RS resource indicator (CRI), layer indication (LI), rank indication (RI), and reference signal received power (L1-RSRP). The UE may receive, via an RRC message received from the base station, N reporting settings (CSI-ReportConfig), M resource settings (CSI-ResourceConfig), and one ReportTriggerList that is a list of trigger states. Here, N and M which are multiple constant values may configured via RRC, and may have different values. The list may include CSI-ReportConfigs indicating resource set IDs corresponding to channel and interference, and may be used for triggering reporting on corresponding resource sets.

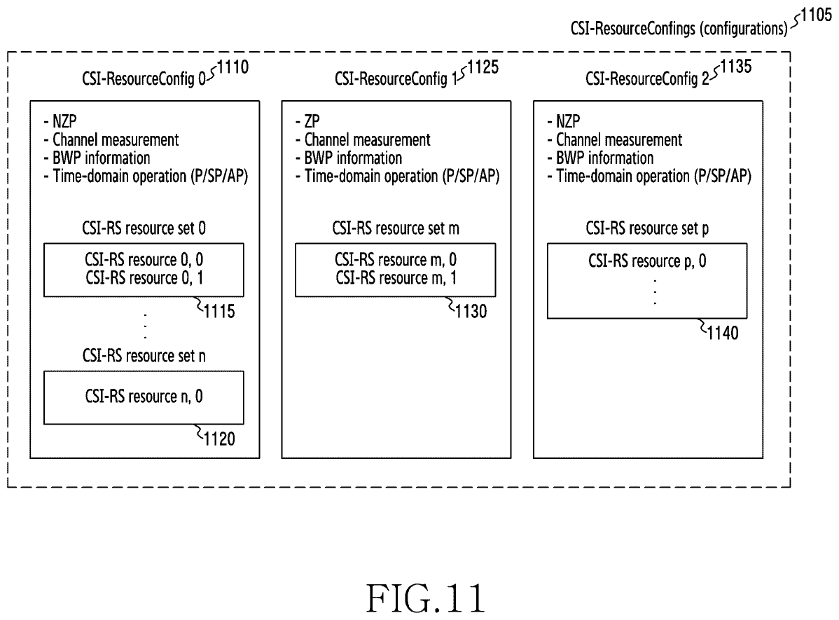

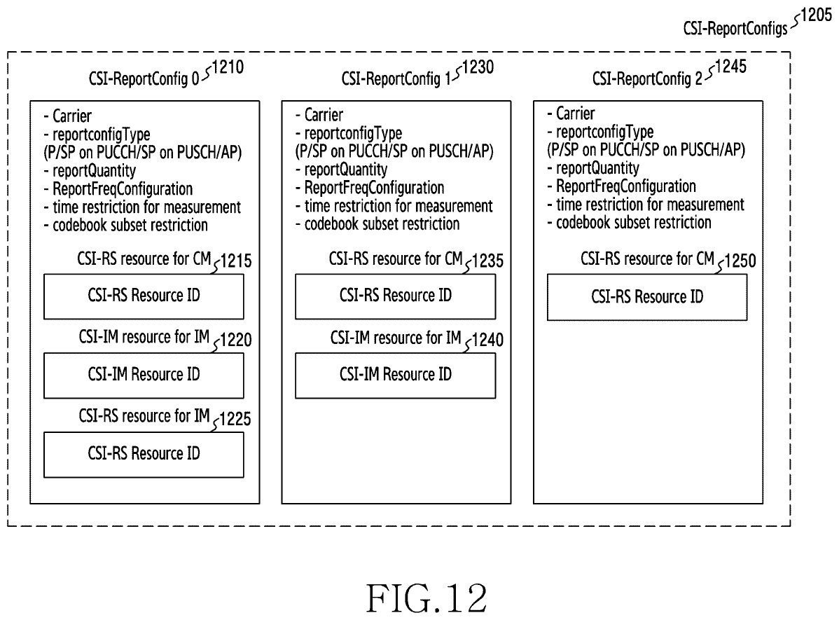

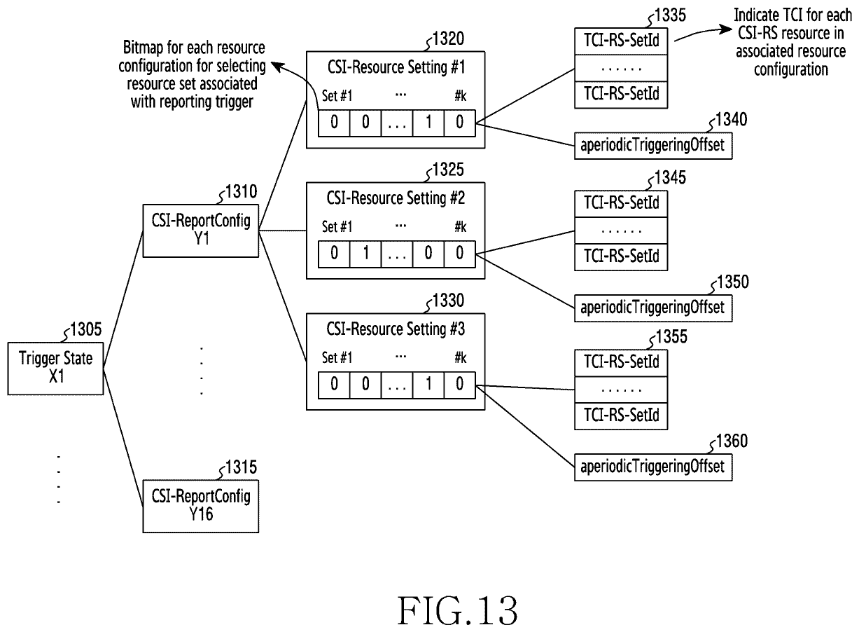

According to various embodiments of the disclosure, hereinafter, in FIG. 11, FIG. 12, and FIG. 13, methods of configuring and reporting CSI resources (e.g., L1 measurement resources) are described in detail (hereinafter, CSI measurement and L1 measurement are used interchangeably, but may also be used with the same meaning). The overall operations described below may be applicable as subsequent LTM proposed in the disclosure, and hereinafter, embodiments are described focusing on differences. For example, unless otherwise separately described, L1 measurement and reporting operations in LTM may follow the operations described in FIG. 11, FIG. 12, and FIG. 13.

FIG. 11 illustrates a method of configuring channel state information (CSI) resources in a wireless communication system, according to an embodiment of the disclosure.

Referring to FIG. 11, a CSI resource configuration 1105 may include up to 16 CSI resource sets 1115, 1120, 1130, and 1140 in each CSI-ResourceConfig 1110, 1125, or 1135, and the configuration may be applied to a DL BWP configured via an RRC message. In addition, all CSI resource settings (CSI-ResourceConfig) may be connected to CSI report settings configured for the same DL BWP.

CSI resource sets 1115, 1120, 1130, and 1140 may include CSI-RS resources configured with NZP CSI-RS or CSI-IM, and may include synchronization signal (SS)/physical broadcast channel (PBCH) block resources for Layer 1 reference signal reference power (L1-RSRP) calculation. In addition, the CSI-RS resources may be classified by ResourceConfigType in the time domain, and a corresponding type may be configured to be aperiodic (AP), periodic (P), or semi-persistent (SP). However, the number of CSI-RS resource sets for P/SP CSI resource setting is limited to one, and a periodicity and a slot offset in the setting may follow numerology of the DL BWP. In addition, the CSI resource setting may specify channels and interference required to be measured. For example, the CSI resource setting may configure CSI-IM/NZP CSI-RS as interference 1125 or 1135, or may configure the NZP CSI-RS resource 1110 to be used for channel measurement.

FIG. 12 illustrates CSI resource reporting method configuration in a wireless communication system, according to an embodiment of the disclosure.

Referring to FIG. 12, as a CSI reporting method configuration 1205 in the time domain, a report type may be configured to be aperiodic, semi-persistent, or periodic for each CSI-ReportConfig 1210, 1230, or 1245. For P/SP CSI reporting, a configured periodicity and slot offset may be applied to numerology of a corresponding UL BWP, and for aperiodic reporting, transmission resources may be directly indicated via DCI. In addition, a CSI resource reporting configuration may indicate, via ReportQuantity, whether a corresponding CSI report is CSI-related or L1-RSRP-related. ReportFreqConfiguration may indicate reporting granularity in the frequency domain, and may indicate whether a CSI reporting band and a PMI/CQI reporting band are a wideband or a sub-band. Furthermore, for CSI measurement restrictions in the time domain, timeRestrictionForChannelMeasurements and timeRestrictionForInterferenceMeasurements may be configured, and codebook subset restrictions may be provided in CodebookConfig. In addition, one CSI-ReportConfig 1210, 1230, or 1245 may configure an NZP CSI resource set 1215, 1235, or 1250 to be mandatory, and may optionally associate an NZP interference 1225 and an ZP interference 1220 or 1240 with a CSI resource setting. This may indicate that CSI reporting basically includes CSI resources and may additionally perform reporting on interference resources.

As described above, CSI reporting may be configured to be aperiodic (using PUSCH), periodic (using PUCCH), or semi-persistent (using PUCCH and DCI activated PUSCH). Here, associated CSI-RS resources may also be configured as AP/P/SP and transmitted. Hereinafter, [Table 1] indicates how CSI reporting is triggered for each CSI-RS resource.

TABLE 1
CSI reporting triggering/activation for CSI-RS configuration

| CSI-RS | | | |
|---|---|---|---|
| Configuration | Periodic CSI Reporting | Semi-Persistent CSI Reporting | Aperiodic CSI Reporting |
| Periodic | Triggered and reported | 1. Report on PUCCH | DCI indicates triggering |
| CSI-RS | directly through RRC | When SP CSI reporting is | state (triggering state is |
| | settings (reporting | triggered by MAC CE, report | configured via RRC and |
| | based on configured | according to configuration | indicated via MAC CE) |
| | periodicity and | 2. report on PUSCH | |
| | offset value) | DCI triggers SP CSI | |
| | | reporting | |
| Semi- | Not Supported | 1. Report on PUCCH | DCI indicates triggering |
| Persistent | | When SP CSI reporting is | state (triggering state is |
| CSI-RS | | triggered by MAC CE, report | configured via RRC and |
| | | according to configuration | indicated via MAC CE) |
| | | 2. report on PUSCH | |
| | | DCI triggers SP CSI | |
| | | reporting | |
| Aperiodic | Not Supported | Not Supported | DCI indicates triggering |
| CSI-RS | | | state (triggering state is |
| | | | configured via RRC and |
| | | | indicated via MAC CE) |

[2] As illustrated in [Table 1], a CSI-RS configuration may include a CSI resource set configured as either P, SP, or AP for each corresponding resource setting (CSI-ResourceConfig), and CSI resources having the same characteristics may be configured in the set. The CSI resource setting (CSI-ResourceConfig) may be mapped to a specific CSI reporting configuration, and a transmission method of CSI reporting may be configured as one of P/SP/AP transmissions. All P/SP/AP CSI reporting may be configured for P CSI-RS resources, P/SP CSI reporting may be applied to SP CSI resources, and only A CSI reporting may be applied to A CSI resources.

According to an embodiment, for P CSI reporting, reporting may be performed according to a periodicity and an offset value configured via corresponding CSI-ReportConfig of an RRC message. The described operation may be performed without a separate triggering signal.

According to an embodiment, SP CSI reporting may be classified into two types according to a triggering scheme and a physical channel on which CSI reporting is performed. A first type may be a scheme in which SP CSI reporting is triggered by an SP CSI reporting MAC CE, and SP CSI reporting is performed according to a CSI reporting configuration indicated by the MAC CE. This may indicate that CSI may be reported semi-persistently via a PUCCH and may be performed until deactivation is indicated via the SP CSI reporting MAC CE. A periodicity and an offset corresponding to SP CSI reporting may follow values configured in a CSI-ReportConfig RRC configuration. A second type may be a scheme of activating SP CSI reporting via DCI. In this case, for CSI reporting, a list of report slots, periodicities, and offsets may be configured in a CSI-ReportConfig via RRC, and in DCI indicated by csi-RNTI, whether to use a specific offset and periodicity configuration is indicated, and PUSCH CSI reporting may be triggered. The UE having received the DCI may determine activation/deactivation of SP CSI reporting via a PUSCH according to indication (activation/deactivation) included in the DCI. The aforementioned two methods of determining SP CSI reporting may be determined by the base station according to a channel state and a reporting method for transmission (e.g., Quantity). For AP reporting, reportSlotOffsetList may be provided via an RRC configuration (CSI-ReportConfig), and a triggering state in which the aforementioned A CSI reporting configuration has been mapped to CSI-AperiodicTriggerState may be configured. The A CSI reporting may be triggered by the UE receiving a CSI request field of the DCI. The CSI request field of the DCI may be configured to be up to 6 bits, and when the A CSI reporting configuration configured via RRC is greater than 2\hat{ }(CSI request field)−1 (e.g., up to 63), an operation for reducing candidate triggering states via a MAC CE may also be included. Detailed operations of triggering A CSI reporting will be specifically described below.

FIG. 13 illustrates a triggering state configuration for CSI resource reporting in a wireless communication system, according to an embodiment of the disclosure.

In NR, a separate configuration for A CSI reporting has been introduced, in addition to a CSI reporting configuration provided by default in an RRC configuration. This is a method in which a triggering state list for A CSI reporting is configured, and one or multiple corresponding A CSI reports are indicated via DCI. According to an embodiment, first, a list of triggering states may be provided in aperiodicReportTrigger via an RRC configuration. Each triggering state may be associated with one or multiple values of CSI-ReportConfig, and CSI-ReportConfig may be associated with one or multiple P/SP/AP CSI resource settings. If multiple A CSI resource sets are connected to a resource setting, and in a case where A CSI resource sets, i.e., a subset of the multiple CSI resource sets, are associated with a triggering state, only a corresponding configuration may be indicated for the case by using a bitmap.

According to an embodiment, in a triggering state 1305, a trigger state level may be configured to a high level via RRC. The triggering state may be associated with up to 16 values of CSI-ReportConfig(Setting) 1310 and 1315. A CSI-ReportConFig level may be connected to up to three CSI resource settings 1320, 1325, and 1330, which may correspond to an NZP CSI channel, a ZP CSI interference, and an NZP CSI interference, respectively. The CSI resource settings 1320, 1325, and 1330 may indicate, in a bitmap form, CSI resource sets included in corresponding resource settings. In addition, the CSI resource sets may indicate CSI resources 1335, 1345, and 1355 included in the resource sets, and may provide transmission configuration indication reference signal (TCI-RS) state IDs quasi co-located (QCLed) with the corresponding CSI resources. Furthermore, the CSI resource sets may also provide offsets 1340, 1350, and 1360 for aperiodicReportTrigger. The offsets may indicate offsets from DCI triggering to actual transmission of the CSI resource sets.

For example, when an aperiodic triggering state is activated via DCI, reporting on an associated CSI resource set may be performed. According to an embodiment, the reporting may be performed once.

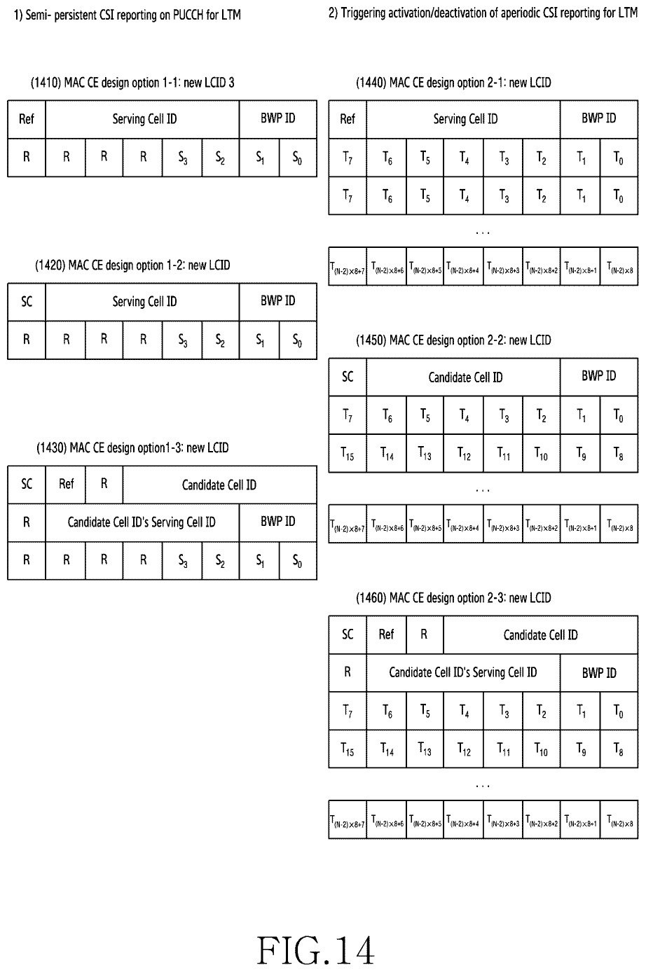

FIG. 14 illustrates an L1/L2 signaling method for supporting a subsequent L1/L2-based handover (L1/L2 triggered mobility (LTM)) operation, according to an embodiment of the disclosure. Specifically, FIG. 14 illustrates an example of a method of controlling, via L1/L2 signaling, L1 measurement resource measurement and reporting for supporting subsequent L1/L2-based handover (LTM) operation.

Referring to FIG. 14, among the L1 measurement and reporting methods described above in FIGS. 11, 12, and 13, operations requiring control via L1 (e.g., DCI) and L2 signaling (e.g., MAC CE), and specific methods for such signaling are described in detail. According to various embodiments of the disclosure, for subsequent LTM-related L1 measurement resources and reporting methods, the aforementioned first L1 measurement resource configuring method/second L1 measurement resource configuring method and first L1 measurement reporting configuring method/second L1 measurement reporting configuring method may be applied.

For example, in various embodiments of the disclosure, the method, described in FIG. 12, of reporting CSI resources that are L1 measurement resources (e.g., CSI reporting triggering/activation for CSI-RS configuration in [Table 1]) may be applied, as it is, even to L1 resource measurement and reporting in subsequent LTM, and only a configuration method therefor may differ. When the L1 measurement resources and reporting methods in [Table 1] described above are applied as they are, the following methods may be applied based particularly on the L1 measurement reporting methods.

### 1. Configuring and Triggering, Via RRC Configuration, Periodic L1 Measurement Reporting (Periodic CSI Reporting)

a. The UE may perform corresponding L1 measurement and periodic reporting immediately by applying an RRC configuration.

### 2. Configuring, Via RRC, Semi-Periodic (e.g., Semi-Persistent) L1 Measurement Reporting (Semi-Persistent CSI Reporting) Through PUCCH Configured, and Indicating, Via MAC CE, Activation/Deactivation of SP CSI Reporting

a. The UE may perform SP CSI reporting indicated via a MAC CE, starting X ms after receiving the MAC CE.
b. The UE may perform reporting periodically until deactivation is indicated via the MAC CE.
c. Detailed configuration for SP CSI reporting (e.g., time-frequency resource and periodicity information, etc.) may be provided via RRC.
d. A new MAC CE structure 1410, 1420, or 1430 may be introduced.

### 3. Configuring, Via RRC, Semi-Persistent L1 Measurement Reporting (Semi-Persistent CSI Reporting) Through PUSCH Configured, and Triggering, Via DCI, Activation/Deactivation of SP CSI Reporting

a. The UE may perform SP CSI reporting indicated via a MAC CE, starting X ms after receiving the MAC CE.
b. The UE may perform reporting periodically until deactivation is indicated via DCI. For example, for subsequent LTM, a new DCI field may be introduced to trigger L1 measurement reporting, or an existing DCI field may be reused.
c. Detailed configuration for SP CSI reporting (e.g., time-frequency resource and periodicity information, etc.) may be provided via RRC.
   4. In Relation to Aperiodic L1 Measurement Reporting (Aperiodic CSI Reporting) Configured Via RRC, and a Triggering State Associated Therewith, Indicating, Via MAC CE, Activation/Deactivation of AP CSI Reporting, and Actually Performing One Triggering Via DCI
a. A MAC CE for activating/deactivating a triggering state may be required.
b. A new MAC CE structure 1440, 1450, or 1460 may be required.
c. DCI may actually activate one of triggering states activated via MAC CE. For example, for subsequent LTM, a new DCI field may be introduced to trigger L1 measurement reporting, or an existing DCI field may be reused.
d. After receiving the DCI, the UE may perform L1 measurement reporting once according to the configuring.

The aforementioned two new MAC CEs will be described in detail below.

### 1) MAC CE for Activating Semi-Persistent L1 Measurement Reporting for Supporting Subsequent LTM (MAC CE of the Semi-Persistent CSI Reporting on PUCCH for LTM)

a. MAC CE Design Method 1-1 1410
Introducing a MAC CE using a new LCID or eLCID.
Ref field: an indicator, in the MAC CE, indicating whether a reporting configuration for activating L1 measurement reporting exists in a reference cell configuration. For example, the field with 1 may indicate that an L1 measurement reporting configuration exists in the reference cell configuration, and the field with 0 may indicate that an L1 measurement reporting configuration exists in a serving cell indicated below instead of in a reference cell.
Serving cell index: may be interpreted differently according to an indication of the Ref field. For example, the Ref field with 1 may indicate a serving cell index existing in the reference cell configuration, and the Ref field with 0 may indicate a current serving cell index.
BWP index: a BWP in which L1 measurement reporting is actually configured in an indicated serving cell.
Sᵢ field: an indicator indicating an activation/deactivation state of semi-persistent L1 measurement reporting configuration. For example, the field with 1 may indicate activation, and the field with 0 may indicate deactivation. In addition, according to an embodiment, referring to FIG. 14, although the Sᵢ field is illustrated to have a size of 4, the disclosed is not limited thereto, and the number (size) of the field may vary according to a configurable number.
   b. MAC CE Design Method 1-2 1420
Introducing a MAC CE using a new logical channel ID (LCID) or enhanced LCID (eLCID)
SC field: an indicator, in the MAC CE, indicating whether a reporting configuration for activating L1 measurement reporting exists in a current serving cell. For example, the field with 1 may indicate that a candidate cell ID is replaceable with a current serving cell index, and the field with 0 may indicate that an L1 measurement reporting configuration exists in an indicated candidate cell ID instead of in the current serving cell.
Candidate cell index (candidate cell ID): may be interpreted differently according to an indication of the SC field. For example, the SC field with 1 may indicate a current serving cell index, and the SC field with 0 may be used as an index indicating a candidate cell (can be used as a logical candidate cell ID, a PCI, or the like).
BWP index: a BWP in which L1 measurement reporting is actually configured in an indicated serving cell.
Sᵢ field: an indicator indicating an activation/deactivation state of semi-persistent L1 measurement reporting configuration. For example, the field with 1 may indicate activation, and the field with 0 may indicate deactivation. In addition, according to an embodiment, referring to FIG. 14, although the Sᵢ field is illustrated to have a size of 4, the disclosed is not limited thereto, and the number (size) of the field may vary according to a configurable number.
   c. MAC CE Design Method 1-3
Introducing a MAC CE using a new LCID or eLCID.
SC field: an indicator, in the MAC CE, indicating whether a reporting configuration for activating L1 measurement reporting exists in a current serving cell. For example, the field with 1 may indicate that a candidate cell ID is replaceable with a current serving cell index, and the field with 0 may indicate that an L1 measurement reporting configuration exists in an indicated candidate cell ID instead of in the current serving cell.
Ref field: an indicator, in the MAC CE, indicating whether a reporting configuration for activating L1 measurement reporting exists in a reference cell configuration. The field with 1 may indicate that an L1 measurement reporting configuration exists in the reference cell configuration, and the field with 0 may indicate that an L1 measurement reporting configuration exists in an indicated serving cell instead of in a reference cell.
Candidate cell index (candidate cell ID): may be interpreted differently according to indications of the SC and Ref fields. For example, the SC field with 1 may indicate a current serving cell index, and for the SC field with 0 and the Ref field with 1, the candidate cell index may be ignored (that is, meaningless). For example, a cell for which L1 measurement reporting has been configured may be used as a reference cell. If both the SC field and the Ref field are 0, these fields may be used as an index indicating a candidate cell (for example, can be used as a logical candidate cell ID, a PCI, or the like).
Serving cell index configured in candidate cell: serving cell indexes for indicating multiple SCells in a configured candidate cell or in the reference cell.
BWP index: a BWP in which L1 measurement reporting is actually configured in an indicated serving cell.
Sᵢ field: an indicator indicating an activation/deactivation state of semi-persistent L1 measurement reporting configuration. For example, the field with 1 may indicate activation, and the field with 0 may indicate deactivation. In addition, according to an embodiment, referring to FIG. 14, although the Sᵢ field is illustrated to have a size of 4, the disclosed is not limited thereto, and the number (size) of the field may vary according to a configurable number.
   2) MAC CE for Activating a Triggering State Associated with Aperiodic L1 Measurement Reporting for Supporting Subsequent LTM (MAC CE of the Triggering State Activation/Deactivation for Aperiodic CSI Reporting for LTM)
   a. MAC CE Design Method 2-1 1440
Introducing a MAC CE using a new LCID or eLCID.
Ref field: an indicator, in the MAC CE, indicating whether a triggering state configuration for activating L1 measurement reporting exists in a reference cell configuration. For example, the field with 1 may indicate that a triggering state configuration for activating L1 measurement reporting exists in the reference cell configuration, and the field with 0 may indicate that a triggering state configuration for activating L1 measurement reporting exists in an indicated serving cell instead of in a reference cell.
Serving cell index: may be interpreted differently according to an indication of the Ref field. For example, the Ref field with 1 may indicate a serving cell index existing in the reference cell configuration, and the Ref field with 0 may indicate a current serving cell index.
BWP index: a BWP in which L1 measurement reporting is actually configured in an indicated serving cell.
Tᵢ field: a field indicating a state of a triggering state configuration for activating aperiodic L1 measurement reporting. The field with 1 may indicate activation, and the field with 0 may indicate deactivation. In addition, according to an embodiment, the Tᵢ field has a size that may vary according to a configurable number.
   b. MAC CE Design Method 2-2 1450
Introducing a MAC CE using a new LCID or eLCID.
SC field: an indicator, in the MAC CE, indicating whether a triggering state configuration for activating L1 measurement reporting exists in a current serving cell. The field with 1 may indicate that a candidate cell ID is replaceable with a current serving cell index, and the field with 0 may indicate that an L1 measurement reporting configuration exists in an indicated candidate cell ID instead of in the current serving cell.
Candidate cell index (candidate cell ID): may be interpreted differently according to an indication of the SC field. For example, the SC field with 1 may indicate a current serving cell index, and the SC field with 0 may be used as an index indicating a candidate cell (for example, can be used as a logical candidate cell ID, a PCI, or the like).
BWP index: a BWP in which L1 measurement reporting is actually configured in an indicated serving cell.
Tᵢ field: a field indicating a state of a triggering state configuration for activating aperiodic L1 measurement reporting. For example, the field with 1 may indicate activation, and the field with 0 may indicate deactivation. In addition, according to an embodiment, the Tᵢ field has a size that may vary according to a configurable number.
   c. MAC CE Design Method 2-3 1460
Introducing a MAC CE using a new LCID or eLCID.
SC field: an indicator, in the MAC CE, indicating whether a triggering state configuration for activating L1 measurement reporting exists in a current serving cell. For example, the field with 1 may indicate that a candidate cell ID is replaceable with a current serving cell index, and the field with 0 may indicate that an L1 measurement reporting configuration exists in an indicated candidate cell ID instead of in the current serving cell.
Ref field: an indicator, in the MAC CE, indicating whether a triggering state configuration for activating L1 measurement reporting exists in a reference cell configuration. For example, the field with 1 may indicate that an L1 measurement reporting configuration exists in the reference cell configuration, and the field with 0 may indicate that an L1 measurement reporting configuration exists in an indicated serving cell instead of in a reference cell.
Candidate cell index (candidate cell ID): may be interpreted differently according to indications of the SC and Ref fields. The SC field with 1 may indicate a current serving cell index, and for the SC field with 0 and the Ref field with 1, the candidate cell index may be ignored (that is, meaningless). For example, a configured cell may be used as a reference cell. If both the SC field and the Ref field are 0, these fields may be used as an index indicating a candidate cell (for example, can be used as a logical candidate cell ID, a PCI, or the like)
BWP index: a BWP in which L1 measurement reporting is actually configured in an indicated serving cell.
Tᵢ field: a field indicating a state of a triggering state configuration for activating aperiodic L1 measurement reporting. The field with 1 may indicate activation, and the field with 0 may indicate deactivation. In addition, according to an embodiment, the Tᵢ field has a size that may vary according to a configurable number.

In the following embodiments, in relation to the methods of SSB-based L1 measurement resource configuration and SSB-based L1 measurement resource reporting for neighboring cells, descriptions will be provided for the overall operations to which the specific methods proposed in the disclosure described above are applied. In particular, for subsequent LTM operations according to various embodiments of the disclosure, an operation of triggering L1 measurement reporting via L1/L2 signaling may be included.

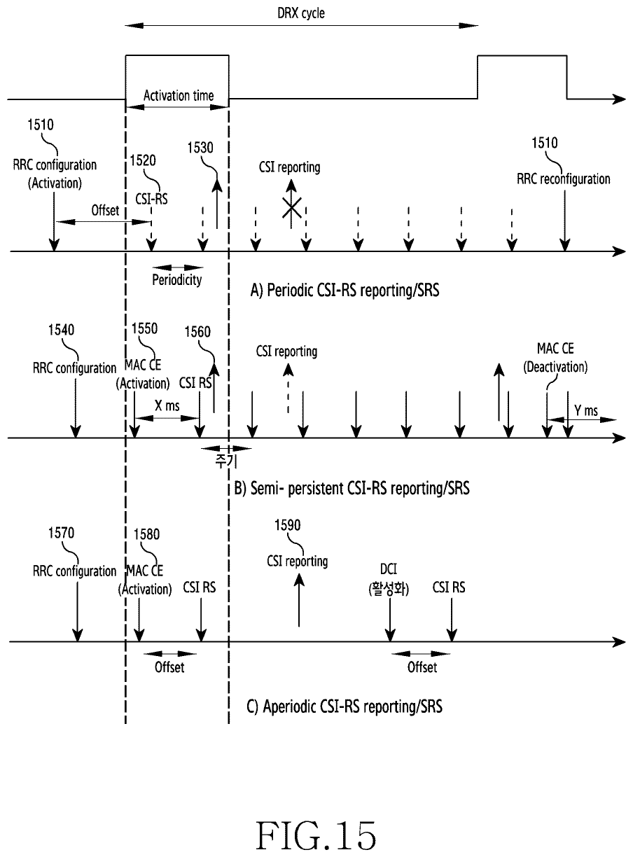

FIG. 15 illustrates a method of transmitting an L1 measurement report for subsequent LTM when DRX is configured and applied, according to an embodiment of the disclosure.

According to an embodiment, FIG. 15 presumes that connected DRX (hereinafter, C-DRX) has been configured for an RRC connected UE. Detailed descriptions of C-DRX operation are provided with reference to FIG. 10, and based on the descriptions, a method of transmitting L1 measurement reporting according to embodiments of the disclosure is defined.

According to an embodiment, a UE configured with C-DRX may basically perform PDCCH monitoring during an active time. For example, by performing PDCCH monitoring during a configured active time, if the UE receives scheduling for DL transmission or scheduling for UL transmission, the UE may start a DRX inactivity timer. The UE may maintain an active state during the DRX inactivity timer. That is, the UE may continue to perform PDCCH monitoring. In addition, the UE may also start an HARQ RTT timer. The HARQ RTT timer may be applied to prevent the UE from unnecessarily monitoring a PDCCH during the HARQ RTT time, and during a timer operation time, the UE does not need to perform PDCCH monitoring. However, while the DRX inactivity timer and the HARQ RTT timer are concurrently operating, the UE may continue PDCCH monitoring based on the DRX inactivity timer.

According to an embodiment, when the HARQ RTT timer expires, a DRX retransmission timer may be started. While the DRX retransmission timer is operating, the UE may perform PDCCH monitoring. In general, during an operation time of the DRX retransmission timer, the UE may receive scheduling information for HARQ retransmission. When the scheduling information is received, the UE may immediately stop the DRX retransmission timer, and restart the HARQ RTT timer. The UE may continue to perform the series of operations described above until a packet is successfully received.

According to an embodiment, since the UE does not perform PDCCH monitoring outside a DRX active time, UL/DL data transmission may not be performed. Similarly, how to perform sounding reference signal (SRS) transmission and CSI reporting configured to be transmitted outside the active time will be defined below. As described above, CSI reporting methods may largely be classified into the following four types.
1. Periodic CSI reporting (P CSI reporting): Reporting at a determined periodicity and offset via configured PUCCH resources.
2. Semi-persistent CSI reporting (SP CSI reporting) via PUCCH: Indicating, via MAC CE, activation/deactivation of SP CSI reporting.
3. Semi-persistent CSI reporting (SP CSI reporting) via PUSCH: Indicating, via DCI, activation/deactivation of SP CSI reporting.
4. Aperiodic CSI reporting (AP CSI reporting): Indicating, via DCI, activation/deactivation of AP CSI reporting.

In step 1510, when the UE is configured with P CSI reporting via an RRC configuration, and performs measurement on a corresponding CSI-RS 1520, if a reporting condition (e.g., periodic reporting or event triggering) is satisfied, the UE may perform 1530 CSI reporting within an active time. However, for a CSI-RS transmitted after the active time, the UE may not perform CSI reporting even if the reporting condition is satisfied. Likewise, even for SRS, when periodic SRS transmission is configured via an RRC message, the UE may transmit 1530 an SRS only within configured resources during the active time. The CSI-RS received by the UE may be periodically transmitted resources.

In step 1540, when the UE is configured with SP CSI reporting via an RRC configuration, and performs measurement on a corresponding CSI-RS, if a reporting condition (e.g., periodic reporting or event triggering) is satisfied, the UE may perform CSI reporting within an active time, or perform CSI reporting even outside the active time. For SP CSI-RS reporting, the base station may activate/deactivate a CSI reporting period via a MAC CE indication 1550, so that, when SP CSI reporting is activated during the active time, the UE may understand that CSI reporting needs to be performed 1560 until a deactivation signal is received. For SP CSI reporting methods, the following methods may be possible.
1. After the DRX active time, no SP CSI reporting is performed.
2. After the DRX active time, among SP CSI reporting activated within the active time, SP CSI reporting transmitted on PUCCH is not performed, and SP CSI reporting transmitted on PUSCH is performed.
3. After the DRX active time, among SP CSI reporting activated within active time, SP CSI reporting transmitted on PUSCH is not performed, and SP CSI reporting transmitted on PUCCH is performed.
4. Even after the DRX active time, all SP CSI reporting activated within the active time is performed.
5. SP CSI reporting activated within the active time is stopped when the active time ends, and SP CSI reporting is restarted according to a corresponding configuration when a subsequent active time starts (for example, stopping SP CSI reporting upon reception of a MAC CE indicating deactivation of the SP CSI reporting).

In step 1570, when the UE is configured with AP CSI reporting via an RRC configuration, and performs measurement on a corresponding AP CSI-RS, if a reporting condition (e.g., periodic reporting or event triggering) is satisfied (DCI triggering) 1580, but resources for AP CSI reporting exist outside the active time, the UE may not perform AP CSI reporting outside the active time, or may perform 1590 AP CSI reporting even outside the active time. For example, the following methods are possible.
1. After the DRX active time, no AP CSI reporting is performed.
2. AP CSI reporting activated within the DRX active time is performed regardless of the active time even after the active time ends.

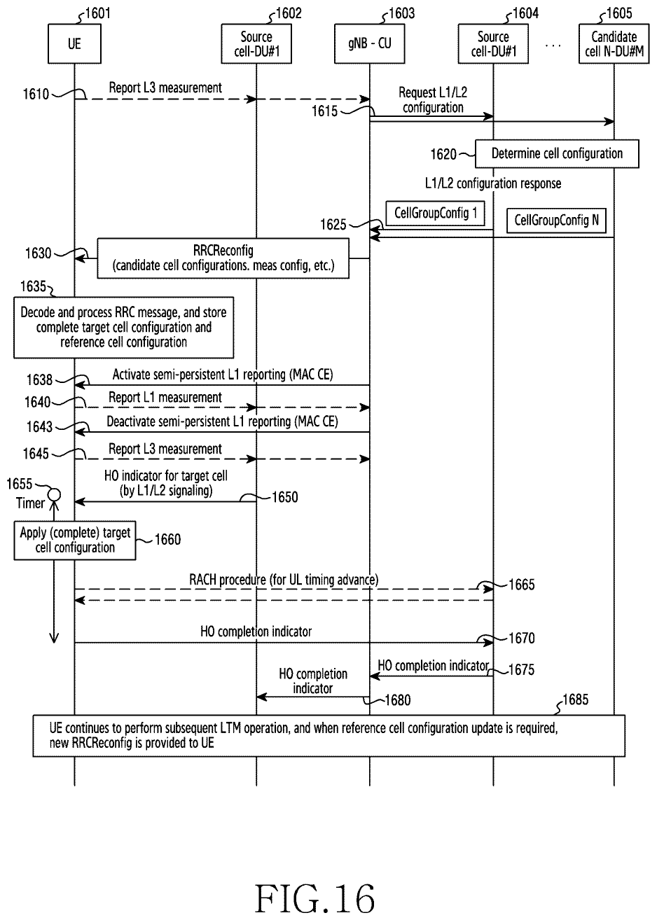

FIG. 16 illustrates a signal flow for semi-persistent L1 measurement reporting to support a subsequent L1/L2-based handover (LTM) operation, according to an embodiment of the disclosure. According to an embodiment, FIG. 16 may include at least one step disclosed in the signal flow of FIG. 6, but this is merely an example, and respective steps are not essential components. Various embodiments may include at least one of all the steps, some of the steps, or a combination of some steps.

According to an embodiment, a UE 1601 in an RRC connected state may perform data transmission and reception to and from source cell 1 1602. In step 1610, the UE may transfer Layer 3 measurement values for a serving cell and neighboring cells to source cell 1 1602 according to configured Layer 3 measurement and reporting. In this case, actual measurement values may be transferred to a base station CU 1603. This is because the base station CU 1603 is responsible for RRC message processing and determines mobility.

In step 1615, the base station CU 1603 may generate a message (e.g., an L1/L2 config request message, a HandoverPreparationInformation message, or a new message) for requesting configuration information for L1/L2-based handover, and transfer the message to neighboring LTM candidate cells 1604 and 1605 via an F1 interface according to the measurement value report received from the UE. Referring to FIG. 16, the candidate cells are illustrated in association with DUs. However, the disclosure is not limited thereto, and the candidate cells and DUs may be mapped 1:1, or multiple candidate cells may be included in one DU. According to an embodiment, the message for requesting configuration information for L1/L2-based handover may also include an existing handover request message, a UE context request message, a UE context modification request message, etc., or may include a new F1 or Xn message. The message for requesting configuration information for L1/L2-based handover may request, from the neighboring cells, acknowledgment of determination as L1/L2-based handover candidate cells, and concurrently request RRC configuration information applied when L1/L2-based handover is performed to a corresponding cell. In addition, the message may also include information for requesting L1 measurement resource and reporting configurations for LTM candidate cells according to various embodiments of the disclosure. The request for L1 measurement resource and reporting configurations may be performed for each candidate cell. Referring to FIG. 16, step 1615 is illustrated as a single procedure, but is not limited thereto, and the operation may also be performed based on inter-node coordination via multiple procedures.

According to an embodiment, although not illustrated in the drawing, an inter-node coordination procedure that may be performed in this step for L1 measurement resource and reporting configurations are as follows.
Step 1: Receiving L1 measurement resource configurations from the LTM candidate cells.
Step 2: The source base station CU 1603 transfers L1 measurement resource configurations for supporting subsequent LTM to the respective candidate cells via the collected L1 measurement resource configurations for the respective candidate cells (e.g., the first L1 measurement resource configuration method or the second L1 measurement resource configuration method).
Step 3: The source base station CU 1603 requests and receives the L1 measurement reporting configurations from the LTM candidate cells.
Step 4: Transferring the LTM-related configuration to the UE (e.g., including an L1 resource reporting configuration configured according to the first L1 measurement resource reporting method).

According to an embodiment, in this case, the source base station CU 1603 may transfer source cell configuration information and separate reference cell configuration information to the neighboring LTM candidate cells 1604 and 1605. According to an embodiment, the message transmitted by the source base station CU 1603 may include the L1 measurement resource configurations for subsequent LTM in the reference cell configuration information.

According to an embodiment, the reference cell configuration information transferred by the source base station CU 1603 to the respective candidate cells 1604 and 1605 may include configuration information (common configuration) applicable in common to multiple target candidate cells in order to reduce signaling overhead that may occur when the target candidate cells provide configuration information for LTM. The common configuration information may include measurement configuration, bearer configuration, or, for cells belonging to the same CellGroup, configurations configured at a CellGroup level (e.g., MAC-CellGroupConfig, RLC bearer configuration, SCell configuration, etc.). If the source base station CU 1603 identifies the configuration information for each candidate cell 1604 or 1605, or there is a procedure of identifying the same, the reference cell configuration may be determined via a separate procedure for obtaining the reference cell configuration information, etc. The source base station CU 1603 transfers the reference cell configuration to each candidate cells 1604 or 1605 in order to enable application of a delta configuration (e.g., a method of configuring a complete configuration by applying a configuration added on top of the reference cell configuration, or a method of configuring a complete configuration after overriding and applying a configuration in a target cell based on the reference cell configuration) by allowing each candidate cell to transfer, to the source base station CU 1603, only configuration information added based on the reference cell configuration. This may be subsequently transferred as is to the UE, thereby reducing RRC message signaling transferred to the UE.

According to an embodiment, in addition, when the source base station CU 1603 transfers the reference cell configuration to each candidate cell 1604 or 1605, if the reference cell configuration can be omitted, the candidate cell configuration may be provided as a complete RRC configuration. The RRC configuration information (CellGroupConfig 1, . . . , CellGroupConfig N) applied when L1/L2-based handover is performed may be transferred at one of a cell group level or an RRC message level. As described above, the message 1615 for requesting configuration information for L1/L2-based handover may be transferred while including the reference cell information and configuration, and may include at least one of indicators indicating to apply a delta configuration to the reference cell configuration information or the configuration information for L1/L2-based handover, and transfers the same to the neighboring candidate cells 1604 and 1605. The indicator may be requested for each cell or may be requested in common for all cells.

In step 1620, the neighboring candidate cells 1604 and 1605 having received the message for requesting configuration information for L1/L2-based handover may generate configuration information of each neighboring candidate cell when L1/L2-based handover has been applied, based on the transferred configuration information of the reference cell by either using the delta configuration or not applying the delta configuration.

In step 1625, each neighboring candidate cell 1604 or 1605 may include the generated configuration information for L1/L2-based handover in a configuration information response message (L1/L2 config response message) for L1/L2-based handover, and transfer the response message to the base station CU 1603.

In step 1630, the base station CU 1603 may transfer, to the source cell 1602, an RRC message generated based on the configuration information received from each candidate cell, and the source cell 1602 may transfer the received message to the UE. The RRC message may include configuration information (Pre-Config1, . . . , Pre-ConfigN) for neighboring candidate cells to which L1/L2-based handover (LTM) is applied. Pre-Config included in the RRC message may include information on CellGroupConfig configurations received from the LTM candidate cells in step 1625, and bearer configurations and Layer 3 (L3) measurement configurations for the LTM candidate cells, which are generated by the base station.

In step 1635, the UE having received the RRC message may decode and process the RRC message. The processing procedure performed by the UE may include ASN.1 decoding and validity determination for the received message, a method of storing or managing configuration details, and the like. In addition, the UE may store, as complete configuration information in a buffer (e.g., memory) of the UE, the LTM configuration information for each candidate cell decoded in step 1635, and at the same time, the UE may also store and manage the received reference cell configuration information in the buffer (e.g., memory) of the UE. According to an embodiment, the reference cell configuration information may be omitted from the RRC message (or the configuration information for each LTM candidate cell) in step 1630. In this case, the UE may identify that there is no reference cell configuration information, and may determine and store, as complete configuration information, the received configuration information for LTM target candidate cells. In this case, the reference cell configuration information may not be separately stored (e.g., operating as empty). For example, no delta configuration may be applied. In addition, via the RRC message, L1 measurement resource and reporting configuration information for subsequent LTM may be transferred. Details of configuration are described in the aforementioned description of the disclosure.

In step 1638, the base station may transfer, to the UE, a MAC CE for activating semi-persistent L1 reporting.

In step 1640, the UE may receive a MAC CE and perform Layer 1 (L1) measurement and reporting for each candidate neighbor cell, and may perform semi-persistent L1 measurement reporting according to the received configuration.

In step 1643, when the UE receives the MAC CE for deactivating semi-persistent L1 reporting, the UE may terminate semi-persistent L1 measurement reporting.

At the same time, in step 1645, the UE may also perform L3 measurement and reporting according to the received configuration.

In step 1650, the source cell having received the L1 measurement report may determine handover based on a corresponding measurement value, and indicate the UE to perform L1/L2 handover. In step 1650, a MAC CE and DCI including a handover indicator may be used as L1/L2 signaling. The L1 measurement value transfer for determining L1/L2 handover and the handover determination in steps 1640 and 1650 may be performed by the source cell (DU) or the source base station CU. If the base station CU makes all determinations, the source cell may transfer, to the base station CU, the L1 measurement value received from the UE, and transfer L1/L2 signaling to the UE according to the handover determination indication of the base station CU. However, if the source cell makes a final determination, the source cell may, without transferring the received L1 measurement value to the base station, determine handover on its own according to a measurement value reference (e.g., a threshold value or a measurement value range) for handover determination for each neighboring candidate cell, the reference being received from the previous base station, and accordingly, the source cell may transfer L1/L2 signaling to the UE.

In step 1655, when the L1/L2 handover indication is transferred to the UE, the UE may start a handover procedure and drive a timer for L1/L2 handover. The timer may be a newly configured timer for LTM, or an existing T304 timer may be reused.

In step 1660, the UE may apply the configuration on the target cell to which L1/L2 handover is applied. For example, the UE may replace the current configuration with the complete configuration information for the indicated LTM target cell, which is stored previously in the UE. This may be one of the LTM neighboring candidate cell configurations previously received in step 1630, and may be a configuration stored in the UE.

In step 1665, according to the applied configuration, the UE may perform random access when random access is required for the target cell, or when random access is neither indicated nor required (for example, when uplink synchronization has already been performed or configured), a random-access procedure may be omitted.

In step 1670, the UE may perform a handover completion procedure with the target cell. The handover completion procedure may be a handover completion procedure for LTM. The procedure may vary according to a handover completion indication method. In addition, if the configuration of the target cell is received at an RRC message level, the procedure may be a procedure of transferring an RRCReconfigurationComplete message. However, if a cell level or cell group level configuration is received, the procedure may be replaced with a new handover completion indication message (e.g., new RRC message or MAC CE).

In addition, since this scenario considers application to intra-CU, the target cell (DU) 1604 having received the handover completion message may transfer the received message to the base station CU 1603 in step 1675. In this case, the handover completion message received via the F1 interface may be transferred as it is, or the target cell 1604 may reprocess the message based on the received information and transfer the same.

In step 1680, the base station CU 1603 may transfer information on handover completion to the source cell 1602, and indicate to release UE context.

As illustrated in step 1685, various embodiments of the disclosure may support subsequent LTM operations. The subsequent LTM operations may include that the LTM configuration information (e.g., configurations for the target candidate cells, the reference cell configuration information, etc.) received by the UE in step 1630 is stored as it is in the UE, and unless the LTM configuration information is changed/released/added via a separate RRC configuration, the UE continues to perform the LTM procedure. If it is necessary to update the reference cell configuration information, new RRC configuration information may be transferred to the UE, and the subsequent LTM operations may be performed. For example, all or some of the aforementioned procedures described in the drawing may be re-triggered and performed.

According to an embodiment, when the UE is provided with the reference cell configuration information in step 1630, the UE may store the same in the UE buffer, and if there is no separate update for configuration, the UE may use the configuration as the reference cell configuration information even after performing LTM (step 1650) (for example, the UE may apply reference cell configuration and LTM candidate configuration values stored in subsequent LTM). In addition, in step 1630, if the UE has failed to be provided with the reference cell configuration information in an RRC connected state, the UE may, according to some of the UE operation options described above, store the reference cell configuration as empty, or may store, as the reference cell configuration information, configuration information for the source cell (PCell) from which the LTM configuration information has been received.

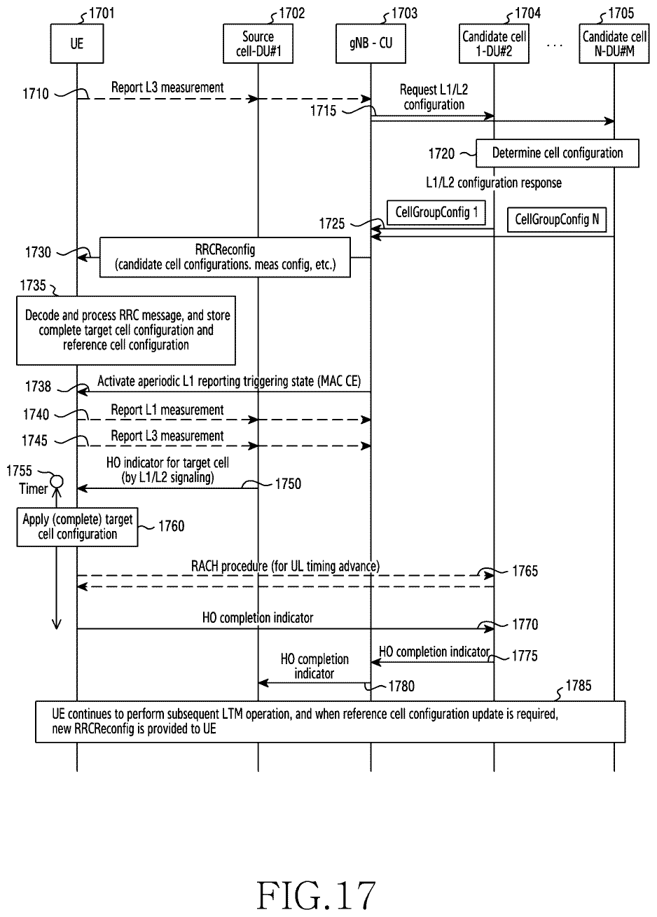

FIG. 17 illustrates an operation in which aperiodic L1 measurement reporting is applied to support a subsequent L1/L2-based handover (LTM) operation, according to an embodiment of the disclosure. According to an embodiment, FIG. 17 may include at least one step disclosed in the signal flow of FIG. 6 or FIG. 16, but this is merely an example, and respective steps are not essential components. Various embodiments may include at least one of all the steps, some of the steps, or a combination of some steps.

According to an embodiment, a UE 1701 in an RRC connected state may perform data transmission and reception to and from source cell 1 1702. In step 1710, the UE may transfer Layer 3 measurement values for a serving cell and neighboring cells to source cell 1 1702 according to configured Layer 3 measurement and reporting. In this case, actual measurement values may be transferred to a base station CU 1703. This is because the base station CU 1703 is responsible for RRC message processing and determines mobility.

In step 1715, the base station CU 1703 may generate a message (e.g., an L1/L2 config request message, a HandoverPreparationInformation message, or a new message) for requesting configuration information for L1/L2-based handover, and transfer the message to neighboring LTM candidate cells 1704 and 1705 via an F1 interface according to the measurement value report received from the UE. Referring to FIG. 17, the candidate cells are illustrated in association with DUs. However, the disclosure is not limited thereto, and the candidate cells and DUs may be mapped 1:1, or multiple candidate cells may be included in one DU. According to an embodiment, the message for requesting configuration information for L1/L2-based handover may also include an existing handover request message, a UE context request message, a UE context modification request message, etc., and may include a new F1 or Xn message. The message for requesting configuration information for L1/L2-based handover may request, from the neighboring cells, acknowledgment of determination as L1/L2-based handover candidate cells, and concurrently request RRC configuration information applied when L1/L2-based handover is performed to a corresponding cell. In addition, the message may also include information for requesting L1 measurement resource and reporting configurations for LTM candidate cells according to various embodiments of the disclosure. The request for L1 measurement resource and reporting configurations may be performed for each candidate cell. Referring to FIG. 17, step 1715 is illustrated as a single procedure, but is not limited thereto, and the operation may also be performed based on inter-node coordination via multiple procedures.

According to an embodiment, although not illustrated in the drawing, an inter-node coordination procedure that may be performed in this step for L1 measurement resource and reporting configurations are as follows.
Step 1: Receiving L1 measurement resource configurations from the LTM candidate cells.
Step 2: The source base station CU 1703 transfers L1 measurement resource configurations for supporting subsequent LTM to the respective candidate cells via the collected L1 measurement resource configurations for the respective candidate cells (e.g., the first L1 measurement resource configuration method or the second L1 measurement resource configuration method).
Step 3: The source base station CU 1703 requests and receives the L1 measurement reporting configurations from the LTM candidate cells.
Step 4: Transferring the LTM-related configuration to the UE (e.g., including an L1 resource reporting configuration configured according to the first L1 measurement resource reporting method).

According to an embodiment, in this case, the source base station CU 1703 may transfer source cell configuration information and separate reference cell configuration information to the neighboring LTM candidate cells 1704 and 1705. According to an embodiment, the message transmitted by the source base station CU 1703 may include the L1 measurement resource configurations for subsequent LTM in the reference cell configuration information.

According to an embodiment, the reference cell configuration information transferred by the source base station CU 1703 to the respective candidate cells 1704 and 1705 may include configuration information (common configuration) applicable in common to multiple target candidate cells in order to reduce signaling overhead that may occur when the target candidate cells provide configuration information for LTM. The common configuration information may include measurement configuration, bearer configuration, or, for cells belonging to the same CellGroup, configurations configured at a CellGroup level (e.g., MAC-CellGroupConfig, RLC bearer configuration, SCell configuration, etc.). If the source base station CU 1703 identifies the configuration information for each candidate cell 1704 or 1705, or there is a procedure of identifying the same, the reference cell configuration may be determined via a separate procedure for obtaining the reference cell configuration information, etc. The source base station CU 1703 transfers the reference cell configuration to each candidate cells 1704 or 1705 in order to enable application of a delta configuration (e.g., a method of configuring a complete configuration by applying a configuration added on top of the reference cell configuration, or a method of configuring a complete configuration after overriding and applying a configuration in a target cell based on the reference cell configuration) by allowing each candidate cell to transfer, to the source base station CU 1703, only configuration information added based on the reference cell configuration. This may be subsequently transferred as is to the UE, thereby reducing RRC message signaling transferred to the UE.

According to an embodiment, in addition, when the source base station CU 1703 transfers the reference cell configuration to each candidate cell 1704 or 1705, if the reference cell configuration can be omitted, the candidate cell configuration may be provided as a complete RRC configuration. The RRC configuration information (CellGroupConfig 1, . . . , CellGroupConfig N) applied when L1/L2-based handover is performed may be transferred at one of a cell group level or an RRC message level. As described above, the message 1715 for requesting configuration information for L1/L2-based handover may be transferred while including the reference cell information and configuration, and may include at least one of indicators indicating to apply a delta configuration to the reference cell configuration information or the configuration information for L1/L2-based handover, and transfers the same to the neighboring candidate cells 1704 and 1705. The indicator may be requested for each cell or may be requested in common for all cells.

In step 1720, the neighboring candidate cells 1704 and 1705 having received the message for requesting configuration information for L1/L2-based handover may generate configuration information of each neighboring candidate cell when L1/L2-based handover has been applied, based on the transferred configuration information of the reference cell by either using the delta configuration or not applying the delta configuration.

In step 1725, each neighboring candidate cell 1704 or 1705 may include the generated configuration information for L1/L2-based handover in a configuration information response message (L1/L2 config response message) for L1/L2-based handover, and transfer the response message to the base station CU 1703.

In step 1730, the base station CU 1703 may transfer, to the source cell 1702, an RRC message generated based on the configuration information received from each candidate cell, and the source cell 1702 may transfer the received message to the UE. The RRC message may include configuration information (Pre-Config1, . . . , Pre-ConfigN) for neighboring candidate cells to which L1/L2-based handover (LTM) is applied. Pre-Config included in the RRC message may include information on CellGroupConfig configurations received from the LTM candidate cells in step 1725, and bearer configurations and Layer 3 (L3) measurement configurations for the LTM candidate cells, which are generated by the base station.

In step 1735, the UE having received the RRC message may decode and process the RRC message. The processing procedure performed by the UE may include ASN.1 decoding and validity determination for the received message, a method of storing or managing configuration details, and the like. In addition, the UE may store, as complete configuration information in a buffer (e.g., memory) of the UE, the LTM configuration information for each candidate cell decoded in step 1735, and at the same time, the UE may also store and manage the received reference cell configuration information in the buffer (e.g., memory) of the UE. According to an embodiment, the reference cell configuration information may be omitted from the RRC message (or the configuration information for each LTM candidate cell) in step 1730. In this case, the UE may identify that there is no reference cell configuration information, and may determine and store, as complete configuration information, the received configuration information for LTM target candidate cells. In this case, the reference cell configuration information may not be separately stored (e.g., operating as empty). For example, no delta configuration may be applied. In addition, via the RRC message, L1 measurement resource and reporting configuration information for subsequent LTM may be transferred. Details of configuration are described in the aforementioned description of the disclosure.

In step 1738, the base station may transfer, to the UE, a MAC CE for activating aperiodic L1 reporting, and transfer DCI for activating the MAC CE.

In step 1740, the UE may receive the MAC CE and DCI to perform Layer 1 (L1) measurement and reporting for each neighboring candidate cell, and may perform aperiodic L1 measurement reporting according to the received configuration.

At the same time, in step 1745, the UE may also perform L3 measurement and reporting according to the received configuration.

In step 1750, the source cell having received the L1 measurement report may determine handover based on a corresponding measurement value, and indicate the UE to perform L1/L2 handover. In step 1750, a MAC CE and DCI including a handover indicator may be used as L1/L2 signaling. The L1 measurement value transfer for determining L1/L2 handover and the handover determination in steps 1740 and 1750 may be performed by the source cell (DU) or the source base station CU. If the base station CU makes all determinations, the source cell may transfer, to the base station CU, the L1 measurement value received from the UE, and transfer L1/L2 signaling to the UE according to the handover determination indication of the base station CU. However, if the source cell makes a final determination, the source cell may, without transferring the received L1 measurement value to the base station, determine handover on its own according to a measurement value reference (e.g., a threshold value or a measurement value range) for handover determination for each neighboring candidate cell, the reference being received from the previous base station, and accordingly, the source cell may transfer L1/L2 signaling to the UE.

In step 1755, when the L1/L2 handover indication is transferred to the UE, the UE may start a handover procedure and drive a timer for L1/L2 handover. The timer may be a newly configured timer for LTM, or an existing T304 timer may be reused.

In step 1760, the UE may apply the configuration on the target cell to which L1/L2 handover is applied. For example, the UE may replace the current configuration with the complete configuration information for the indicated LTM target cell, which is stored previously in the UE. This may be one of the LTM neighboring candidate cell configurations previously received in step 1730, and may be a configuration stored in the UE.

In step 1765, according to the applied configuration, the UE may perform random access when random access is required for the target cell, and when random access is neither indicated nor required (for example, when uplink synchronization has already been performed or configured), a random-access procedure may be omitted.

In step 1770, the UE may perform a handover completion procedure with the target cell. The handover completion procedure may be a handover completion procedure for LTM. The procedure may vary according to a handover completion indication method. In addition, if the configuration of the target cell is received at an RRC message level, the procedure may be a procedure of transferring an RRCReconfigurationComplete message. However, if a cell level or cell group level configuration is received, the procedure may be replaced with a new handover completion indication message (e.g., new RRC message or MAC CE).

In addition, since this scenario considers application to intra-CU, the target cell (DU) 1704 having received the handover completion message may transfer the received message to the base station CU 1703 in step 1775. In this case, the handover completion message received via the F1 interface may be transferred as it is, or the target cell 1704 may reprocess the message based on the received information and transfer the same.

In step 1780, the base station CU 1703 may transfer information on handover completion to the source cell 1702, and indicate to release UE context.

As illustrated in step 1785, various embodiments of the disclosure may support subsequent LTM operations. The subsequent LTM operations may include that the LTM configuration information (e.g., configurations for the target candidate cells, the reference cell configuration information, etc.) received by the UE in step 1730 is stored as it is in the UE, and unless the LTM configuration information is changed/released/added via a separate RRC configuration, the UE continues to perform the LTM procedure. If it is necessary to update the reference cell configuration information, new RRC configuration information may be transferred to the UE, and the subsequent LTM operations may be performed. For example, all or some of the aforementioned procedures described in the drawing may be re-triggered and performed.

According to an embodiment, when the UE is provided with the reference cell configuration information in step 1730, the UE may store the same in the UE buffer, and if there is no separate update for configuration, the UE may use the configuration as the reference cell configuration information even after performing LTM (step 1750) (for example, the UE may apply reference cell configuration and LTM candidate configuration values stored in subsequent LTM). In addition, in step 1730, if the UE has failed to be provided with the reference cell configuration information in an RRC connected state, the UE may, according to some of the UE operation options described above, store the reference cell configuration as empty, or may store, as the reference cell configuration information, configuration information for the source cell (PCell) from which the LTM configuration information has been received.

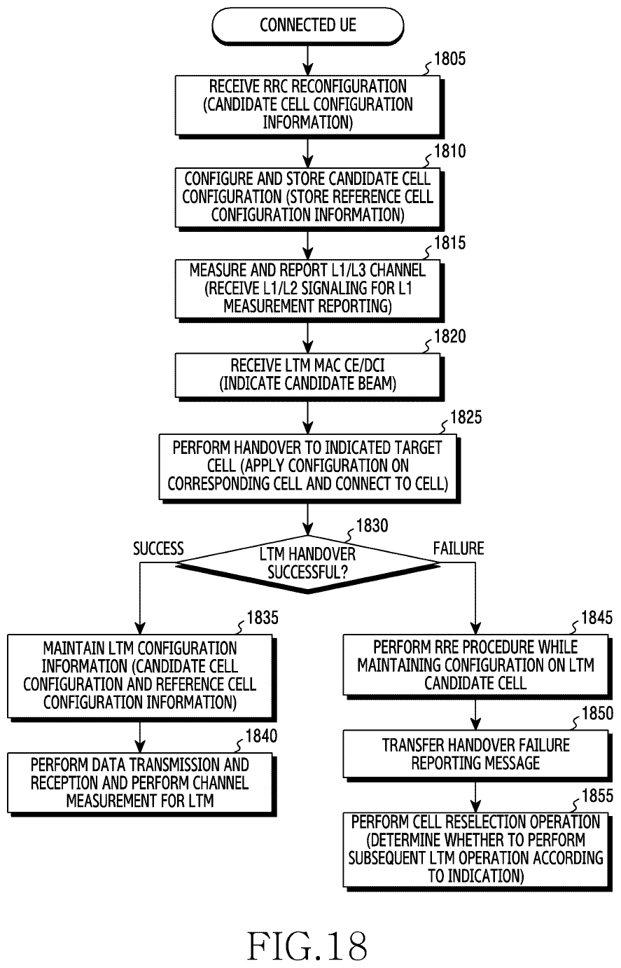

FIG. 18 illustrates another operation flow of a UE for performing L1/L2-based beam changing and handover, according to an embodiment of the disclosure. In particular, a UE operation according to various embodiments of the disclosure may be characterized by a method of performing L1 measurement and reporting according to L1 measurement resource and reporting configurations for subsequent LTM operations.

In step 1805, a connected UE may receive, via an RRC reconfiguration message from a serving cell, configuration information related to neighboring cells, which is applied after L1/L2-based mobility is indicated. Specific configuration methods and details are described in FIGS. 10 and 11. In addition, referring to FIG. 1n, although omitted prior to RRC configuration information and not illustrated, the UE may have received a basic RRC configuration from a base station, and may perform an operation of reporting Layer 3 measurement values for neighboring cells. In particular, the configuration information in the LTM candidate cells, which is received in step 1805 and applied after L1/L2-based mobility is indicated, may be transferred by applying a delta configuration based on a configuration for one reference cell. The UE may identify a reference cell and configuration information for the reference cell, which are previously identified or indicated via RRC configuration. Configurations for neighboring cells other than the reference cell have the reference cell configuration in common, and are transferred as additional configurations, so that signaling overhead may be reduced. In the configuration step described above, the UE may receive resource and reporting-related configuration information for L1 measurement on the LTM candidate cells. For detailed configuration methods, reference may be made to the aforementioned first L1 measurement resource configuration method/second L1 measurement resource configuration method and first L1 measurement reporting configuration method/second L1 measurement reporting configuration method.

In step 1810, the UE may decode the received configurations for LTM candidate cells, based on the configuration of the reference cell, and may store and manage an actually applied complete configuration (e.g., an operation of storing a configuration, to which a delta configuration has been applied based on the reference cell, as a complete configuration by referring to the reference cell configuration) in a separate buffer and list. Alternatively, the UE may store and manage the received RRC configurations as they are in the buffer, without decoding the received configurations based on the reference cell, and storing and managing the actually applied configuration. As described with reference to FIG. 10, when the UE receives a configuration in which the reference cell configuration is omitted, the UE may identify that there is no reference cell configuration information, and may determine and store, as complete configuration information, the received configuration information for the LTM target candidate cells. In this case, the UE may not separately store reference cell configuration information (e.g., operating as empty). For example, no delta configuration may be applied. In this step, an advantage generated by the UE decoding the configurations for the neighboring cells based on the reference cell and storing an actually applied configuration may be that, when an actual L1/L2-based handover is indicated, the handover to a corresponding cell may be applied immediately, resulting in no additional delay.

In step 1815, the UE may perform L1 measurement associated with the neighboring candidate cells while maintaining the connection to the serving cell, and may report corresponding measurement results to the serving cell according to the preconfigured L1 measurement reporting configuration method. In this step, the base station may control, via the RRC configurations and L1/L2 signaling, L1 measurement resource reporting for the neighboring LTM cells that need to be measured. The UE may perform L1 measurement resource reporting according to the configuration and indication of the base station. In addition, independently of this operation, the UE may measure the neighboring cells according to an L3 measurement configuration, and report corresponding measurement results to the base station according to an L3 measurement reporting configuration. The serving cell may determine, based on the received measurement results, whether to perform beam change and whether to perform handover for the UE.

In step 1820, if a change to a specific beam of the neighboring cells is determined to be necessary rather than a specific beam of the serving cell, the serving cell may indicate, via L1/L2 signaling, the handover and beam change for the UE. Referring to FIG. 1n, the L1/L2 signaling may be a MAC CE and DCI, wherein the MAC CE may indicate information indicating both a specific beam of the neighboring cells and a change of the serving cell (e.g., a case where the MAC CE indicates only one beam), or the MAC CE may indicate multiple specific beams of an LTM target cell, and subsequently transmitted DCI may indicate a handover for which one of multiple beams of the neighboring cells, which are activated by the MAC CE, is selected.

In step 1825, the UE may identify whether handover is indicated from the MAC CE and DCI signaling received in step 1815, and perform an LTM handover operation. When the MAC CE and DCI indicate handover (e.g., a case where the MAC CE itself indicates handover, or the MAC CE activates multiple beams, and the DCI indicates handover while indicating one of the beams), the UE may perform handover to a cell associated with an indicated TCI state.

In step 1830, when random access is successfully performed and the handover succeeds, the UE may also apply the configuration for the LTM target cell stored in step 1810.

In step 1835, the UE may maintain the previously stored LTM configuration information and reference cell configuration information.

In step 1840, the UE may connect to the indicated LTM target cell, and perform data transmission and reception using the indicated beam. The UE may perform channel measurement reporting according to the LTM configuration, and may continue to perform subsequent LTM operations.

If the UE fails LTM handover in step 1830, the UE may attempt to fallback to the previous source cell for connection in step 1845. To this end, the UE may need to maintain the configuration information for the source cell even if LTM is triggered. In addition, even after the fallback to the source cell, the UE may maintain the LTM configuration information and reference cell configuration information for the LTM target cell. This may be to allow LTM to be re-triggered according to the existing configuration. If the fallback to the source cell cannot be completely performed, the UE may perform an RRC re-establishment procedure to reselect connectible cells. If a cell found via cell reselection is one of the LTM candidate cells, the UE may attempt connection by applying a preconfigured RRC configuration for the cell.

In step 1850, the UE may generate a handover failure reporting message and transfer the message to the base station in the connected cell (e.g., the source cell or the target cell). The handover failure reporting message may include UEInformationResponse or another uplink RRC message. In addition, the UE may report this via a new MAC CE or uplink control information (UCI). Information included in the handover failure reporting message may include the following information.
An indicator indicating that handover has failed due to an LTM failure.
Information on a target cell to which LTM has been attempted and has failed: LTM cell configuration index or actual cell index (physical cell index (PCI)) information.

According to an embodiment, the source base station may identify, via the handover failure message reporting, that the LTM attempt has failed and fallback to the corresponding cell has been performed. In addition, if a cell found via cell reselection after an RRC re-establishment procedure is not one of the LTM candidate cells, the UE may maintain, in step 1855, the LTM configuration information and reference cell configuration information stored in the cell. Alternatively, in this case, the UE may release the stored LTM-related configuration information and reference cell configuration information. Alternatively, the base station may explicitly specify an operation to the UE via configuration.

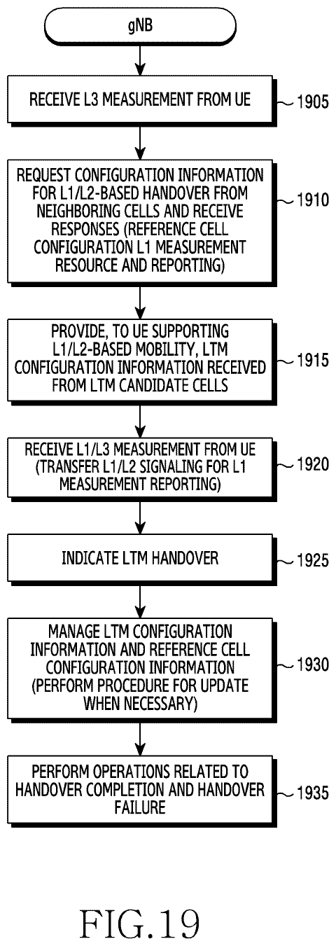

FIG. 19 illustrates another operation flow of a base station for performing L1/L2-based beam changing and handover, according to an embodiment of the disclosure.

In step 1905, a base station may receive an L3 measurement value report from a UE, and may identify whether the UE requires handover, which cells are handover candidate cells, etc., based on measurement values of the UE with respect to neighboring frequencies and cells.

In step 1910, the base station may request configuration information for L1/L2-based handover from the neighboring cells, and receive responses from the cells. In this step, the base station may transfer both configuration information for the current source cell and reference cell configuration information to the neighboring cells. The base station may receive, from the neighboring cells and LTM candidate cells, RRC configuration information to which a delta configuration is applied based on reference cell configuration information. In addition, in this step, inter-node coordination for L1 measurement resource and reporting configuration according to various embodiments of the disclosure may be performed. Reference may be made to the aforementioned first L1 measurement resource configuration method/second L1 measurement resource configuration method and first L1 measurement reporting configuration method/second L1 measurement reporting configuration method. Although omitted in this drawing, prior to this step, a configuration related to L3 measurement configuration and a basic RRC configuration may have been provided.

In step 1915, the base station may transfer, to the connected UE, an RRC configuration message generated including the neighboring cell configuration information and L1 measurement resource/reporting configuration received in step 1910. For example, the base station may transfer the configuration information of the neighboring cells, which is applied after L1/L2-based mobility is indicated, from a serving cell via an RRC reconfiguration message. Detailed configuration methods and content have been specifically described in FIGS. 10 and 11.

In step 1920, according to L1 measurement and reporting that the base station desires to configure and trigger, the base station may indicate, via RRC or L1/L2 signaling, various methods of L1 measurement reporting. The base station may receive a report on L1 and L3 measurement values from the UE, in which case, an L1 measurement value may indicate a neighboring cell (non-serving cell) supporting L1/L2-based mobility. The serving cell may determine, based on the received measurement result, whether to perform beam change and whether to perform handover for the UE. If the serving cell determines that a change from a specific beam of the serving cell to a specific beam of the neighbor cell is necessary, the serving cell may indicate, in step 1925, LTM handover for the UE via L1/L2 signaling. The L1/L2 signaling may be a MAC CE or DCI, and may include information indicating a change to a specific beam of the neighboring cells. In addition, in this step, the existing handover may also be independently performed and indicated via the RRC message. This may occur because the base station and the serving cell determine LTM and Layer 3 handover independently of each other.

In step 1935, when the base station receives a handover completion message from the UE, the base station may identify that the LTM operation has been successfully completed, and accordingly, may notify the previous source cell of the handover completion and request release of UE context. In addition, when the base station receives a handover failure reporting message including information indicating that the handover has failed, the base station may receive a message indicating that the UE has attempted to reconnect to the corresponding cell after the handover failure. The handover failure reporting message may include UEInformationResponse or another uplink RRC message. In addition, the base station may receive this via a new MAC CE or uplink control information (UCI). Information included in the handover failure reporting message may include the following information.
An indicator indicating that handover has failed due to an LTM failure.
Information on a target cell to which LTM has been attempted and has failed: LTM cell configuration index or actual cell index (physical cell index (PCI)) information.

The source base station may identify, via the handover failure message reporting, that the LTM attempt has failed and fallback to the corresponding cell has been performed.

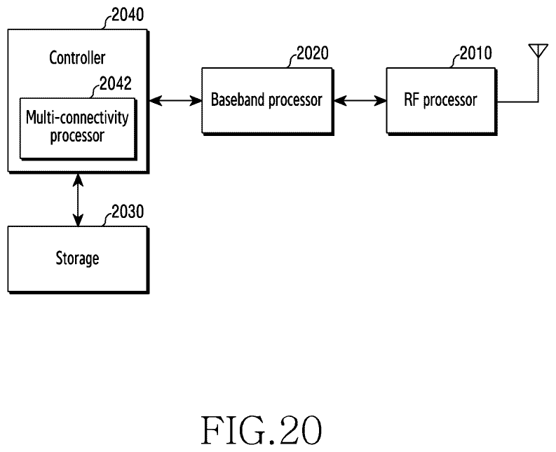

FIG. 20 illustrates a functional structure of a UE according to an embodiment of the disclosure.

Referring to FIG. 20, the UE may include a radio frequency (RF) processor 2010, a baseband processor 2020, a storage 2030, and a controller 2040.

The RF processor 2010 may perform a function for transmitting and receiving a signal via a wireless channel, such as band conversion and amplification of the signal. That is, the RF processor 2010 may up-convert a baseband signal provided from the baseband processor 2020 to an RF band signal, may transmit the same through an antenna, and may down-convert an RF band signal received through the antenna to a baseband signal. For example, the RF processor 2010 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 2010 may include multiple RF chains. Furthermore, the RF processor 2010 may perform beamforming. For the beamforming, the RF processor 2010 may adjust the phase and magnitude of signals transmitted/received through multiple antennas or antenna elements, respectively. In addition, the RF processor may perform MIMO, and may receive multiple layers when performing a MIMO operation.

The baseband processor 2020 may perform functions of conversion between baseband signals and bitstrings according to the system's physical layer specifications. For example, during data transmission, the baseband processor 2020 may encode and modulate a transmitted bitstring to generate complex symbols. In addition, during data reception, the baseband processor 2020 may demodulate and decode a baseband signal provided from the RF processor 2010 to restore a received bitstring. For example, when following the orthogonal frequency division multiplexing (OFDM) scheme, during data transmission, the baseband processor 2020 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 2020 may split a baseband signal provided from the RF processor % n at the OFDM symbol level, may restore signals mapped to subcarriers through a fast Fourier transform (FFT) operation, and may restore a received bitstring through demodulation and decoding.

The baseband processor 2020 and the RF processor 2010 may transmit and receive signals as described above. Therefore, the baseband processor 2020 and the RF processor 2010 may be referred to as a transmitter, a receiver, a transceiver, or a communication unit. Furthermore, at least one of the baseband processor 2020 and the RF processor 2010 may include multiple communication modules to support multiple different radio access technologies. In addition, at least one of the baseband processor 2020 and the RF processor 2010 may include different communication modules to process signals in different frequency bands. For example, the different radio access technologies may include a wireless LAN (e.g., IEEE 802.11), a cellular network (e.g., LTE), and the like. In addition, the different frequency bands may include super high frequency (SHF) (e.g., 2NRHz) bands and millimeter wave (mmWave) (e.g., 60 GHz) bands.

The storage 2030 may store basic programs, application programs, and data, such as configuration information, for operation of the main base station. Particularly, the storage 2030 may store information regarding a second access node configured to perform wireless communication by using a second radio access technology. In addition, the storage 2030 may provide the stored data at the request of the controller 2040.

The controller 2040 controls overall operations of the UE. For example, the controller 2040 may transmit/receive signals through the baseband processor 2020 and the RF processor 2010. In addition, the controller 2040 records data in the storage 2030 and reads the data from the storage 2030. To this end, the controller 2040 may include at least one processor. For example, the controller 2040 may include a communication processor (CP) configured to perform control for communication, and an application processor (AP) configured to control upper layers such as application programs.

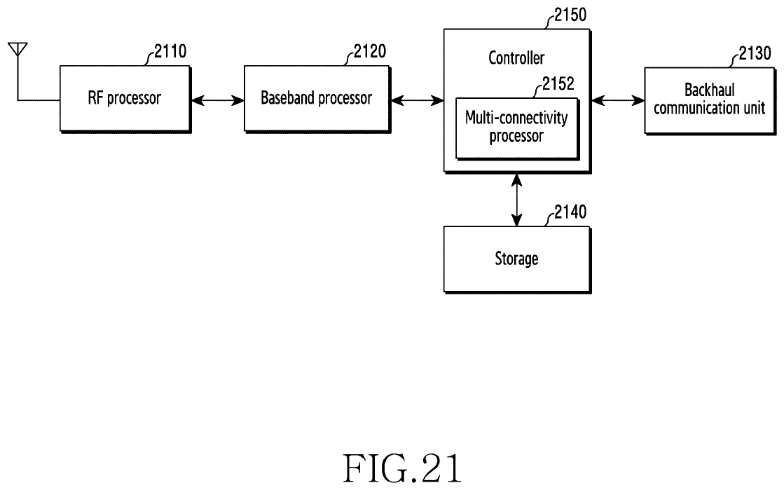

FIG. 21 illustrates a functional structure of a base station according to an embodiment of the disclosure.

Referring to FIG. 21, the base station may include an RF processor 2110, a baseband processor 2120, a backhaul communicator 2130, a storage 2140, and a controller 2150.

The RF processor 2110 may perform a function for transmitting and receiving a signal via a wireless channel, such as band conversion and amplification of the signal. That is, the RF processor 2110 may up-convert a baseband signal provided from the baseband processor 2120 to an RF band signal, may transmit the same through an antenna, and may down-convert an RF band signal received through the antenna to a baseband signal. For example, the RF processor 2110 may include a transmission filter, a reception filter, an amplifier, a mixer, an oscillator, a DAC, and an ADC. Although only one antenna is illustrated in the drawing, the first access node may include multiple antennas. In addition, the RF processor 2110 may include multiple RF chains. Furthermore, the RF processor 2110 may perform beamforming. For the beamforming, the RF processor 2110 may adjust the phase and magnitude of signals transmitted/received through multiple antennas or antenna elements, respectively. The RF processor may transmit one or more layers to perform a downward MIMO operation.

The baseband processor 2120 may perform functions of conversion between baseband signals and bitstrings according to the physical layer specifications of first radio access technology. For example, during data transmission, the baseband processor 2120 may encode and modulate a transmitted bitstring to generate complex symbols. In addition, during data reception, the baseband processor 2120 may demodulate and decode a baseband signal provided from the RF processor 2110 to restore a received bitstring. For example, when following the OFDM scheme, during data transmission, the baseband processor 2120 may encode and modulate a transmitted bitstring to generate complex symbols, may map the complex symbols to subcarriers, and may configure OFDM symbols through IFFT operation and CP insertion. In addition, during data reception, the baseband processor 2120 may split a baseband signal provided from the RF processor 2110 at the OFDM symbol level, may restore signals mapped to subcarriers through FFT operation, and may restore a received bitstring through demodulation and decoding. The baseband processor 2120 and the RF processor 2110 may transmit and receive signals as described above. Therefore, the baseband processor 2120 and the RF processor 2110 may be referred to as a transmitter, a receiver, a transceiver, or a communication unit.

The backhaul communication unit 2120 provides an interface to perform communication with other nodes within a network. That is, the backhaul communication unit 2130 converts bitstrings transmitted from the main base station to other nodes, for example, an auxiliary base station, a core network, etc., into physical signals, and converts physical signals received from the other nodes into bitstrings.

The storage 2140 may store basic programs, application programs, and data, such as configuration information, for operation of the main base station. Particularly, the storage 2140 may store information regarding a bearer allocated to a connected UE, a measurement result reported from the connected UE, and the like. In addition, the storage 2140 may store information serving as a reference to determine whether to provide multi-connectivity to a UE or to suspend the same. In addition, the storage 2140 may provide the stored data at the request of the controller 2150.

The controller 2150 controls the overall operation of the main base station. For example, the controller 2150 transmits/receives signals through the baseband processor 2120 and the RF processor 2110 or through the backhaul communication unit 2130. In addition, the controller 2150 records data in the storage 2140 and reads the data from the storage 2140. To this end, the controller 2150 may include at least one processor.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A central unit (CU) in a wireless communication system, the CU comprising:
a transceiver; and
a controller coupled to the transceiver,
wherein the controller is configured to:
transmit, to a distributed unit (DU), a request message including L1/L2 triggered mobility (LTM) resource configuration information; and
receive, from the DU, a response message including LTM reporting configuration information.

2. The CU of claim 1, wherein a resource included in the LTM resource configuration information is associated with a synchronization signal (SS)/physical broadcasting channel (PBCH) block (SSB).

3. The CU of claim 1, wherein the LTM reporting configuration information is generated based on the LTM resource configuration information.

4. The CU of claim 1, wherein the request message comprises a UE context setup request message or a UE context modification request message.

5. A distributed unit (DU) in a wireless communication system, the DU comprising:
a transceiver; and
a controller coupled to the transceiver,
wherein the controller is configured to:
receive, from a central unit (CU), a request message including L1/L2 triggered mobility (LTM) resource configuration information; and
transmit, to the CU, a response message including LTM reporting configuration information.

6. The DU of claim 5, wherein a resource included in the LTM resource configuration information is associated with a synchronization signal (SS)/physical broadcasting channel (PBCH) block (SSB).

7. The DU of claim 5, wherein the LTM reporting configuration information is generated based on the LTM resource configuration information.

8. The DU of claim 5, wherein the request message comprises a UE context setup request message or a UE context modification request message.

9. A method performed by a central unit (CU) in a wireless communication system, the method comprising:
transmitting, to a distributed unit (DU), a request message including L1/L2 triggered mobility (LTM) resource configuration information; and
receiving, from the DU, a response message including LTM reporting configuration information.

10. The method of claim 9, wherein a resource included in the LTM resource configuration information is associated with a synchronization signal (SS)/physical broadcasting channel (PBCH) block (SSB).

11. The method of claim 9, wherein the LTM reporting configuration information is generated based on the LTM resource configuration information.

12. The method of claim 9, wherein the request message comprises a UE context setup request message or a UE context modification request message.

13. A method performed by a distributed unit (DU) in a wireless communication system, the method comprising:
receiving, from a central unit (CU), a request message including L1/L2 triggered mobility (LTM) resource configuration information; and
transmitting, to the CU, a response message including LTM reporting configuration information.

14. The method of claim 13, wherein a resource included in the LTM resource configuration information is associated with a synchronization signal (SS)/physical broadcasting channel (PBCH) block (SSB).

15. The method of claim 13,
wherein the LTM reporting configuration information is generated based on the LTM resource configuration information; and
wherein the request message comprises a UE context setup request message or a UE context modification request message.
